(19) United States
(12) Patent Application Publication
(10) Pub. No.: US 2010/0080361 A1
(43) Pub. Date: Apr. 1, 2010

(54) Method for Sharing Audio-only content, Audio-Visual content, and Visual-only content between Subscribers on a Telephone call

(76) Inventor: Conrad Edward Houghton, McKinney, TX (US)

Correspondence Address: Conrad Edward Houghton, 4421 Cordova Lane, McKinney, TX, 75070, US

(21) Appl. No.: 12/240,693

(22) Filed: Sep. 29, 2008

(51) Int. Cl. H04M 1/64; H04M 11/00

(52) U.S. Cl. 379/87; 379/93.25

(57) ABSTRACT

A method for controlling the sharing of Audio-only content, Audio-Visual content, and Visual-only content between Subscribers on a Telephone call after it is in a talking state. The Content Sharing service could be offered to telephony subscribers where it becomes another vertical telephony feature like Ring-Back Tone service. The Subscriber to this Content Sharing service will be given the ability to access and select content that will be played while on an active telephone call. All the subscribers connected on the telephone call will be given the ability to control the playing of the content. The content itself will be managed by a centralized Content Server allowing control by the Content Providers of the content provided to subscribers. The content being shared can be stored centrally on a server or be content stored directly by the user on their terminal devices. Additionally, a method of control over content playback, similar to that offered in Content Sharing service, is defined to enhance Ring-Back Tone service and Video Ring-Back Tone service.

### REFERENCES CITED

1. US Patent Application Publication 20050207555 September 2005 Lee et al. METHOD AND APPARATUS FOR MANAGING PRESENTING AND CHANGING RING-BACK SOUNDS IN SUBSCRIBER-BASED RING-BACK SOUND SERVICE.

2. U.S. Pat. No. 7,248,851 July 2007 Lee et al. Method for controlling routing information for intellectual peripherals in subscriber-based ring-back-tone-service.

3. International Telecommunications Union Telecommunications Standardization Sector (ITU-T) Recommendation H.323 Packet-based multimedia communications systems, Series H: AUDIOVISUAL AND MULTIMEDIA SYSTEMS, Infrastructure of audiovisual services—Systems and Terminal equipment for audiovisual services.

4. 3^{rd} Generation Partnership Project (3GPP) Recommendation 3G-324M Mobile Video Telephony over Circuit Switched Networks.

5. U.S. Pat. No. 5,509,009 Apr. 16, 1996 Laycock et al. Video and aural communications system.

### BACKGROUND OF INVENTION

The field of endeavor to which this invention pertains is Telephony and more specifically: the call signaling associated with providing a means to share audio and visual content between telephone subscribers.

The Ring-Back Tone service description and operation, as it applied to audio content on a telephony network, was first covered by the United States Patent Application Publication US20050207555A1 which was published on Sep. 22, 2005. The title given to this patent application was: METHOD AND APPARATUS FOR MANAGING PRESENTING AND CHANGING RING-BACK SOUNDS IN SUBSCRIBER-BASED RING-BACK SOUND SERVICE. This Patent Application Publication was classified as being US Class 379/207.16. This classification is defined to be: US Class: 379 (Telephonic Communications)/207.16 (Ringing Signal part of 207.2 Service controlled by predetermined ringing pattern).

The 5 Korean inventors identified in the original Ring-Back Tone service US Patent Application Publication were subsequently the Inventors listed under the U.S. Pat. No. 7,248,851 which was titled: Method for controlling routing information for intellectual peripherals in subscriber-based ring-back-tone-service. This United States Patent was classified as US Class: 455 (Telecommunications)/401 (Single channel telephone carrier: Including call signaling (e.g. ringing, off-hook, dialing). The Ring-Back Tone service is more about the method of controlling telephone call signaling for the purposes of presenting customized Ring-Back Tones to incoming Callers, accordingly the US Class 455/401 classification better captures the purpose of the Ring-Back Tone patent. Similarly, the Method being claimed under this Patent Application is most appropriately classified within the Telecommunications field and more specifically the signaling required to support a new telephony feature.

### BACKGROUND ART

A Ring-Back Tone service was first launched into the Korean mobile telephony market in May 2002 by SK Telecom Company of the Korean Republic. The RingBack Tone service was commercially successful and has subsequently spread to other mobile telephony markets worldwide. Telecommunication Industry analysts have reported, in 2006 and 2007, that the Ring-Back Tone service has helped generate significant mobile telephony subscriber revenue for the mobile telephony service providers. The predominant audio content used in the Ring-Back Tone service worldwide in 2007, consists of popular music tracks.

The Ring-Back Tone service description and operation as it applied to audio content on a telephony network was first covered by the United States Patent Application Publication US20050207555A1 which was published on Sep. 22, 2005. The 5 Korean inventors identified in the original Ring-Back Tone service US Patent Application Publication were subsequently the Inventors listed under the U.S. Pat. No. 7,248,851 which was titled: Method for controlling routing information for intellectual peripherals in subscriber-based ring-back-tone-service. These two patents describe the state of the art today for Ring-Back Tone service that provides audio content to telephone subscribers.

Video Telephony has copied the audio telephony network capabilities for controlling calls as well as providing all the various service features used in Wireline and Wireless telephony. For example, a video telephony network (implemented according to current Telecommunications standards) would support a subscriber feature such as Incoming Caller Identification. Given the commercial success of Ring-Back Tone service, since it was first deployed in Korea in 2002, the video telephony networks would be expected to support a similar type of Video Ring-Back Tone service.

The International Telecommunications Union, Telecommunication Standardization Sector (ITU-T), has already defined standards for Packet-based video-telephony. One specific reference on this topic is Recommendation H.323 Packet-based multimedia communications systems, Series H: AUDIOVISUAL AND MULTIMEDIA SYSTEMS, Infrastructure of audiovisual services—Systems and Terminal equipment for audiovisual services.

The 3^{rd} Generation Partnership Program (3GPP) is an organization focused on the evolution of mobile telephony. The 3GPP Recommendation 3G-324M Mobile Video Telephony over Circuit Switched Networks defines how to implement Mobile Video-telephony in a hybrid circuit switched and packet switched network. It is relevant to note that Video Ring-Back Tone Service was a defined to be one of the vertical features supported in this mobile video telephony network.

One obvious difference between Video Ring-Back Tone service and the Ring-Back Tone service is that regular telephony Ring-Back Tone service is audio only which uses the speech path capabilities of the existing Wireless and Wireline telephony networks to provide the Ring-Back Tone service. No special subscriber terminals are required in Ring-Back Tone service because Wireline telephones and mobile telephone terminals both provide two-way audio capability necessary to support speech. A Video Ring-Back Tone service would require that the subscriber terminals have a visual display capable of supporting an audio-visual message delivered from a Video Ring-Back Tone Server (which is an Intelligent Peripheral connected to the telephony network).

While Video Telephony is not widely deployed in any commercial network in the world to date, various people in the Telecom industry have speculated that the Video Ring-Back Tone service would be a valuable feature to provide to subscribers.

Problems with Ring-Back Tone service (including Video Ring-Back Tone service):
1) The Ring-Back Tone service only plays audio content to incoming callers. It provides no mechanism for a subscriber to play audio content on an outgoing call. Unlike a normal telephone conversation, Ring-Back Tone service is not a simultaneous two-way communication. The Ring-Back Tone service subscriber can not call someone else up and play their Ring-Back Tone with the person they just called.
2) The Ring-Back Tone service is not an actively shared experience between the two parties on the telephone call. Only the incoming caller will hear the audio content that the subscriber of the Ring-Back Tone service had previously selected. The Ring-Back Tone service subscriber does not get to listen to the audio content during a call. The Ring-Back Tone service subscriber is therefore obliged to remember what audio selection they had made previously when in a conversation with an incoming caller. This offers no opportunity for a shared experience between the Ring-Back Tone service subscriber and the incoming caller with regard to the audio content played.
3) The Ring-Back Tone service is not directly controllable by either party on the call. The audio content, provided by the Ring-Back Tone service, is pre-selected by the subscriber ahead of any incoming call. There is no ability by the subscriber to select audio content after the call has started. Also, there is no ability by the incoming caller to mute the particular Ring-Back Tone service audio selection unless they entirely turn off their speech path which would make it impossible for them to hear when the call is answered by the called party. There will be occasions when an Incoming Caller would desire the ability to mute the Ring-Back Tone service audio content without otherwise impacting the call.
4) The Ring-Back Tone service is limited in the time it has to play the audio (or audio visual message). In North America the average time interval between a call to a mobile subscriber being answered is just over 7 seconds. The amount of audio content that can be played in this small interval is limited. In commercially deployed Ring-Back Tone service in United States in 2007, the incoming caller will typically hear only a small portion of a popular music audio track.
5) The Ring-Back Tone service (audio content only) does not work with a Terminal Device for Deaf (TDD) type terminal. The reasons why audio content such as popular music cannot be played on a Terminal Device for Deaf is obvious. While text messages could be added to the audio content, this defeats the purpose of playing back popular music tracks common to most Ring-Back Tone Subscribers. Video telephony has more promise for the hearing impaired in that it is designed to present both visual content and audio content but is still affected by this problem.

Problems with Music sharing between IP equipped mobile terminals:
6) Transmission of music tracks between two telephony subscribers using the capabilities of Internet Protocol (IP) enabled terminals is technically feasible but runs into Digital Rights Management issues. Given the amount of lost revenue the Entertainment Industry had witnessed between 1997 and 2007, due to illegal copying of music tracks, the content providers are understandably concerned about technologies that allow uncontrolled sharing.

In the U.S. Pat. No. 5,509,009, from Apr. 16, 1996 Laycock et al. claim an aural and video communication system that uses the telephone system and dial-up connections. This system can be used for video-conferencing, remote surveillance or desktop services. They claim that this communications system can provide concurrent aural and video communication. The aural communication takes place over the party's telephone terminal and the video communication uses either video capable personal computing terminals or dedicated video camera & monitor equipments. The primary limitation in this communication system is the requirement that both the aural and video communications must be connected to, switched by, and transported by the 64 kbps Public Switched Telephony Network. The PSTN was designed to carry 64 kbps encoded speech and it is very inefficient at carrying video which requires a higher bandwidth signal.

### BRIEF SUMMARY OF INVENTION

It is the objective of the present invention to provide a method for controlling the sharing of audio only content, audio-visual content, and visual only content, which is centrally stored on a content server, between all parties on a telephone call after it is in a talking state. The subscriber to this service will be given the ability to access and select content that will be played while on an active telephone call. All parties involved in the telephone call will be given the ability to control the playing of the content. The content itself will be managed by a centralized content server allowing better control of the content provided to subscribers.

### BRIEF DESCRIPTION OF THE SEVERAL VIEWS OF THE DRAWING

FIG. 1 is a Call flow for claim 1. It identifies the key elements and method proposed to support the new content sharing service between telephone subscribers who are on a telephone call that is in a talking state. This particular Method of providing Content Sharing is called the Telephony Model because the Content Sharing service is under the control of the telephone switch.

FIG. 2 and FIG. 3 show Call flows for claim 2. It shows the Method by which either party in the call can mute the audio portion of the content being played or restart playing of the audio content being shared.

FIG. 4 is a Call flow for claim 3 where the subscriber to the Content Sharing service selects new content to be shared while on an active telephone call. The newly selected content is then played to all subscribers on the telephone call.

FIG. 5 is a Call flow for claim 7. It identifies the key elements and method proposed to support the new content sharing service between telephone subscribers who are on a telephone call that is in a talking state. This particular Method of providing Content Sharing is called the Subscriber Direct Model. The Call flow in FIG. 5 is different from the Call flow in FIG. 1 because it uses a different Method to accomplish the same purpose of providing a means for subscribers to share content on a telephone call.

FIG. 6 is a Call flow for claim 8. It shows the Method by which a subscriber in the call, who is not the subscriber with the content sharing service) can mute the audio portion of the content being played. The Call flow in FIG. 6 differs from the Call flow in FIG. 2 because it uses a different method to accomplish the same function of muting the audio playback. The different method of muting the content is required because of the differences between providing Content Sharing via the Subscriber Direct Model versus providing Content Sharing via the Telephony Model.

FIG. 7 is a Call flow based upon claim 16. It identifies the key elements and method proposed to support the new content sharing service between telephone subscribers who are on a telephone call that is in a talking state. The Call flow in FIG. 7 is different from the Call flow in FIG. 1 and FIG. 5 because it uses a different Method to accomplish the same function of providing a means for subscribers to share content on a telephone call.

FIG. 8 is a Call flow for claim 17. It starts after step 7 in FIG. 1. This is a variation of the Content Sharing service which is caused by the bridging on of another party to the telephone call which is already up in a Content Sharing session. The Call flow shows the Method for providing Content Sharing to a third subscriber added to the existing telephone call between two subscribers.

FIG. 9 is a network diagram of a Content Server architecture designed to support a large number of transactions expected of a telephony network in a large urban region. The functions required to be performed by the Content Service would be distributed across multiple servers so as to provide the necessary capacity and redundancy required to support a telephone network with more than 1 million subscribers. This figure is provided for context.

FIG. 10 is a Decision Flow chart for claim 15. It identifies the key decision points and logic flow required when supporting both Ring Back Tone and Video Ring Back Tone features on a subscribers telephone.

FIG. 11 is Decision Flow chart for claim 1 and claim 4. It identifies the key decision points and logic flow performed by the Content Server to establish a Content Sharing service in the Telephony Model.

FIG. 12 is a Decision flow chart used for claim 3 and claim 6. It identifies the key decision points and logic flow performed by the Content Server to provide a menu of content to be played to the subscriber of the Content Sharing service.

FIG. 13 is a Call flow of a Classic Ring-Back Tone service shown to contrast the enhancements proposed by this Invention in FIG. 14. It is provided for context.

FIG. 14 is a Call flow for claim 13. It identifies the method and key elements to enhance Ring-Back Tone service where the Calling party, listening to the Ring-Back Tone, is able to stop the Ring-Back Tone playing without otherwise impacting the telephone call.

FIG. 15 is a Call flow for claim 14. It identifies the method and key elements to enhance Video Ring-Back Tone Service where the incoming caller, listening to the Ring-Back Tone, is able to mute the audio portion of the Video Ring-Back Tone playing while continuing to view the visual portion of the audio-visual Video Ring-Back Tone.

FIG. 16 is a Call Flow for claim 15. It identifies the method and key elements to enhance Video Ring-Back Tone Service where the Content Sharing subscriber, is able to select whether the Calling party will receive Video Ring-Back Tone or audio-only Ring-Back Tone.

FIG. 17 is a Call flow for a Video Ring Back Service call. It identifies the method and key elements to enhance user control over the playback of Video Ring-Back Tones. It is provided for context.

FIG. 18 is a Call flow for claim 14. It identifies the method and key elements to enhance user control over the playback of Video Ring Back service by halting playback of audio and visual content.

FIG. 19 and 20 are Call Flows for claim 4. It identifies the method and key elements to provide telephony operator controlled Content Sharing of audio-visual content between subscribers. The audio-visual call flow differs by using additional network elements and messaging between audio-only content provided over facilities in the speech telephony network.

FIG. 21 is a Call Flow for claim 5. It identifies the method and key elements to allow user control of audio-visual playback of content being shared in a telephony operator controlled Content Sharing method.

FIGS. 22 and 23 are Call Flows for claim 7. It identifies the method and key elements to provide Content Sharing directly controlled by the subscriber.

FIG. 24 is a Call Flow for claim 8. It identifies the method and key elements to allow users to control the audio-visual content playback and selection of content in a Content Sharing method controlled directly by the subscriber.

FIGS. 25 and 26 are Call Flows for claim 18. It identifies the method and key elements to provide Content Sharing between a mobile subscriber and Wireline telephony subscriber who also has a personal computer equipped with video capability and connected to a data network.

### DETAILED DESCRIPTION OF THE INVENTION

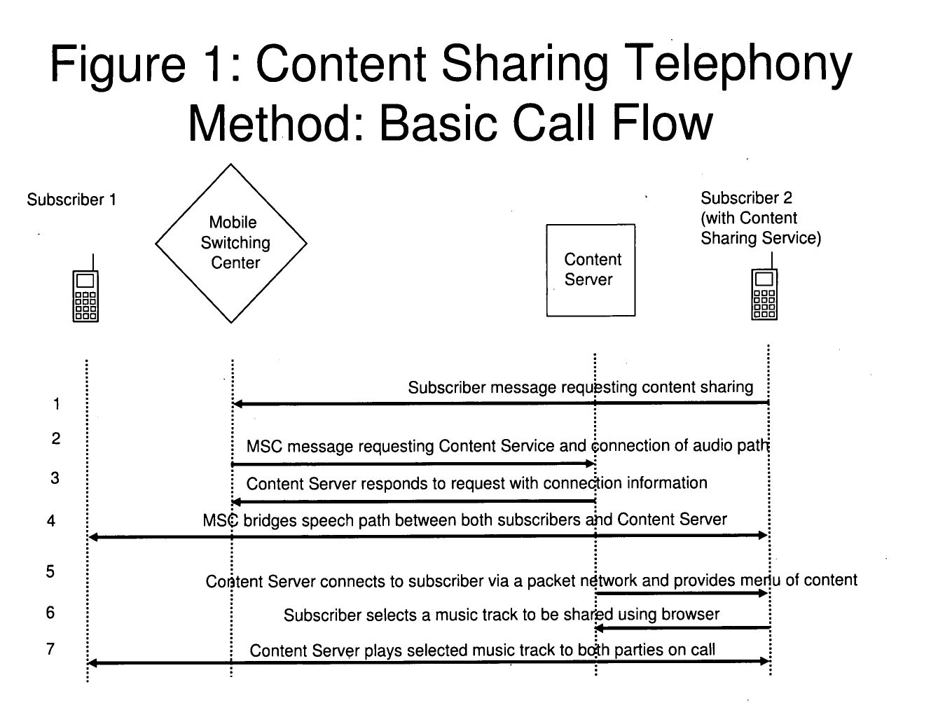

In FIG. 1, the invention starts after a telephone Call is in a talking state between Subscriber 1 and Subscriber 2. In this Content Sharing Call Flow, a Mobile Telephony network is displayed where both subscribers on the call are hosted by the same Mobile Switching Center (MSC). The Content Sharing service would equally work if the subscribers were on different switches the only difference being extra call signaling to establish a physical speech path set-up between the various telephony network elements involved in the telephone call. Not shown is the regular mobile telephony call set-up which includes the MSC sending a message to the Home Location Register (HLR) to obtain the Subscribers profile which, in this scenario, includes information about the Content Sharing service. Note that the Content Sharing service could equally work in Wireline telephones. In a Wireline network, no HLR or MSC would be involved. The Wireline telephone switch hosting the call for subscriber with the Content Sharing service would be control the Content sharing session request and would connect to the Content server. The content to be shared can be audio-only content, audio-visual content, or visual-only content subject to the limitations of the Subscribers' terminals to play the content and subject to the telephony networks ability to deliver the content to the subscriber's terminals. In the example Call flow in FIG. 1, audio-only content in the form of a music track was used to illustrate the Content Sharing service.
1. Subscriber 1 and Subscriber 2 are in a talking state on a telephone call on a Mobile Switching Center. It does not matter which subscriber originated the call. It only matters that one Subscriber has the Content Sharing service option available to them on this telephone network controlled by the Mobile Switching Center anchoring this call. In this example scenario in FIG. 1, it is Subscriber 2, who has the Content Sharing Service option. Subscriber 2 decides they want to play a music track (a typical example of content) on the call to Subscriber 1. Subscriber 2 sends a signal from their handset to the Mobile Switching Center anchoring the telephone call requesting Content Sharing service.
2. In this scenario, the MSC is directly connected to a Content Server. A more complex scenario is possible where the Content Server is connected via other nodes in the telephony network. While this more complex networking scenario would require additional signaling through the telephone network nodes involved the overall scenario would not be functionally different. The MSC anchoring the telephone call would send a Content Sharing service request to the Content Server. The Mobile Switching Center sends a signal to the Content Server requesting that Subscriber 2 be given access to Content Sharing service and provides information on the physical audio path (telephone trunk circuit) to be used to connect from the Content Server to the MSC as well as information on the Subscriber 2 who has the Content Service option. The information on Subscriber 2 includes an IP address for their terminal based upon this specific method of the Content Sharing service which has the Content Server connect to the Subscriber for Content selection. An alternative method of Content Sharing service could have Subscriber 2 connect directly to the Content Server after they request Content Sharing from the MSC. In this latter method, the MSC would provide the IP address of the Content Server that was serving the Content sharing request to Subscriber 2 so that their terminal would know where to go to connect to the correct Content Server.
3. The Content Server replies to the MSC's connection request by acknowledging the service request and confirming the physical audio path connection.
4. The MSC uses an audio conferencing resource to bridge the Content Server physical audio path to the physical audio path already being used for speech between the two subscribers. This is effectively a Three Way Call between the Content Server, the Subscriber 1 and the Subscriber 2.
5. In this scenario, the Content Server establishes a packet network connection directly to the Subscriber 2's terminal. A browser session on the mobile terminal is used by Subscriber 2 to select one of the music tracks, from a menu of available content on the Content Server.
6. Subscriber 2 indicates their selection to the Content Server using Browser.
7. The Content Server plays the selected music track on the physical audio path connection and both Subscriber 1 and Subscriber 2 now share the music track on the telephone call.

Content Sharing Telephony Network Changes:

In the Content Sharing Telephony Method, the Content Sharing service becomes a new vertical telephony software feature similar to Calling Party Identification and Display. The Content Sharing feature (CSHR) will require minor changes to the software of the telephone switches in those telephone networks which chose to deploy the Telephony Method of Content Sharing. Note that the Subscriber Direct model of Content Sharing would require no changes to existing telephone switches.
a. The changes required will differ between mobile telephony networks or Wireline telephony networks which will require different signaling and subscriber feature provisioning.
b. The specific changes required will vary by vendor of telephony switches. Note that existing telephone switches meet national and international standards for supporting over 230 vertical telephony features. The capability to add additional telephony features is part of the capability of most commercial telephony switch software.

Specific Requirements to Support CSHR on the telephony Network:
a. Telephony Subscriber datafill indicating the presence of the CSHR Service option.
   i. Subscriber provisioning on mobile telephony networks is contained within the Home Location Register which supports subscriber roaming onto different serving Mobile Switching Centers.
   ii. Telephone switches in the Wireline Public Switched Telephony Network store vertical feature datafill against individual subscriber directory numbers associated with a physical telephony circuit.
b. Telephony network signaling between the telephone switch anchoring the telephone call and the Content Server.
   i. Mobile telephony networks support specialized signaling between MSC's and HLR's to support mobile telephony subscribers.
   ii. Telephone switches in the Wireline network and mobile telephone switches use a variety of standards based signaling methods to support telephone calls between subscribers on their respective networks. The most common method of telephony signaling in United States is Common Chanel Signaling System Number 7. The CCS7 signaling system supports complex vertical features between mobile and Wireline telephone switches today. This includes information required to support Calling Party Identification which would be necessary to send the information to the Content Server to allow content usage tracking.
   iii. Packet switched telephony networks and circuit based telephony networks supporting the Content sharing feature will require slightly different signaling implementations. Of particular interest is the packet switching capability to support service negotiation between subscriber terminals (e.g. using Session Initiation Protocol).

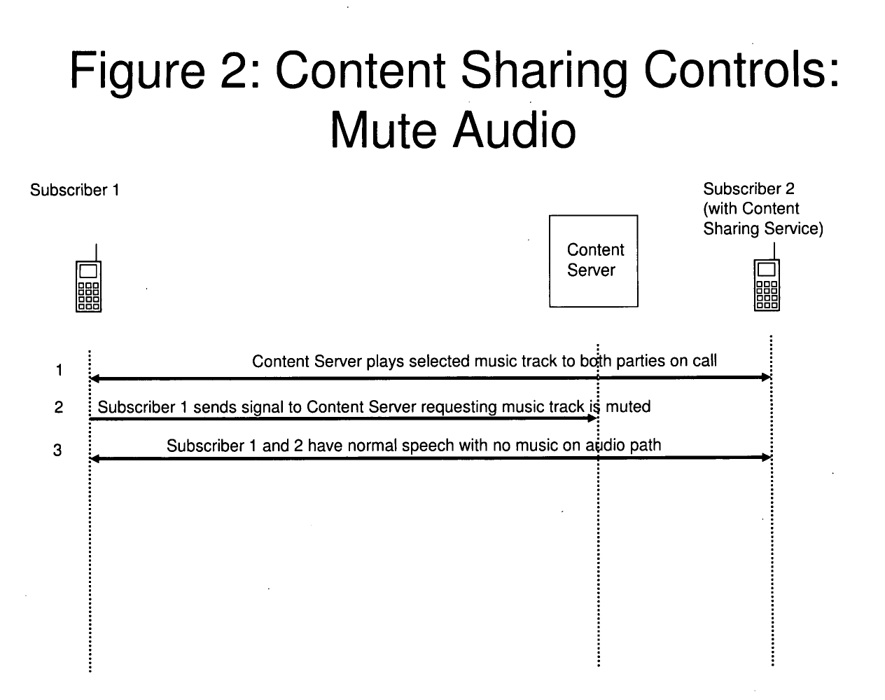

In FIG. 2, the Call Flow begins after the Content Server is playing music track to both parties on a Content Sharing session. This scenario would occur after the call flow in FIG. 1. The scenario described in FIG. 1 used audio-only content. Note that subject to Content Server operator defined policy, the audio portion of an audio-visual message could be muted while the visual content continued to play.
1. Subscriber 1 decides that they want to talk without hearing music on the call. Subscriber 1 sends a signal in-band on the physical audio path from their handset requesting the Content Server stop playing the audio track. This signal would be particular tone or set of tones (e.g. *66) pre-defined by the Content Server operator. The Content Server is listening for these tones on the audio path and when it detects them (from either party on the call), it responds to them as it has been pre-programmed to do. In this scenario, the Content Server hears the DigiTones to mute the music track. Note that the audio bridge connection between the Content Server and the subscribers remains up. It is to be defined by the Content Server operator whether the music track stops playing or whether it continues playing silently until another signal is received. Note that any Subscriber on the Content Sharing call has the capability of muting the audio playback of the content.
2. Subscriber 1 and Subscriber 2 carry on a normal conversation without any music being played on their speech path by the Content Server.

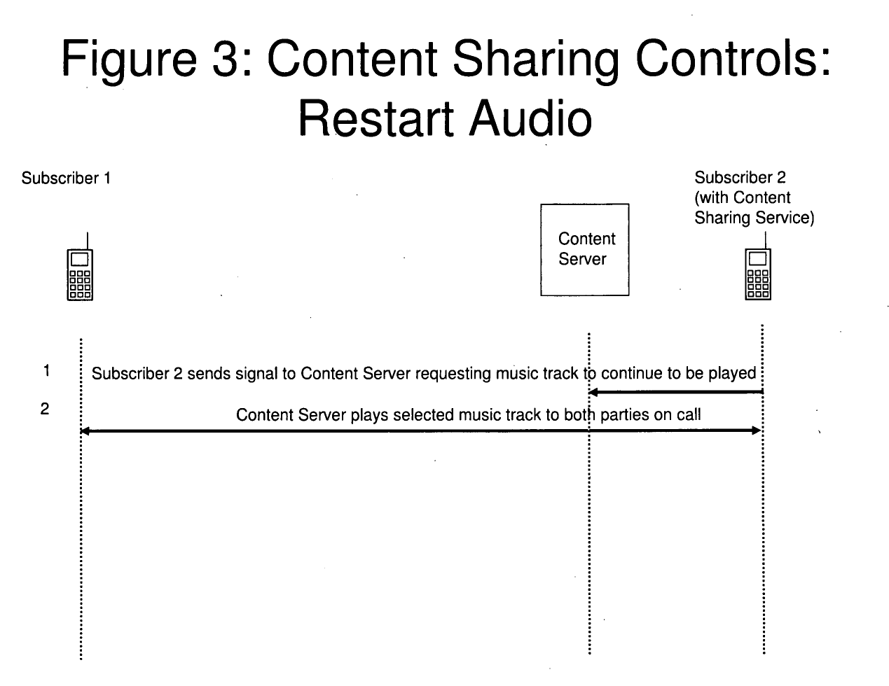

In FIG. 3, the Call Flow begins after the Content Server has muted playing the music track to both parties on a Content Sharing session. This scenario would occur after the Call flow in FIG. 2. The method of restarting the audio playback between Subscriber 1 and Subscriber 2 described in FIG. 3 could equally apply to audio-visual content. In this latter scenario, the muted audio portion, of the audio-visual content being shared, would be restarted.
1. Subscriber 2 decides they want to continue playing the music track so Subscriber 2 signals the Content Server by sending a tone or set of tones in-band on the physical audio path.
2. The Content Server responds to the signal it received from Subscriber 2 and continues to play the music track on the physical audio path between Subscriber 1, Subscriber 2, and the Content Server. Note the Content Server would have responded to an identical set of signals from Subscriber 1 to restart playing the audio. In other words, any subscriber on the Content sharing call has the ability to control the playback of the content.

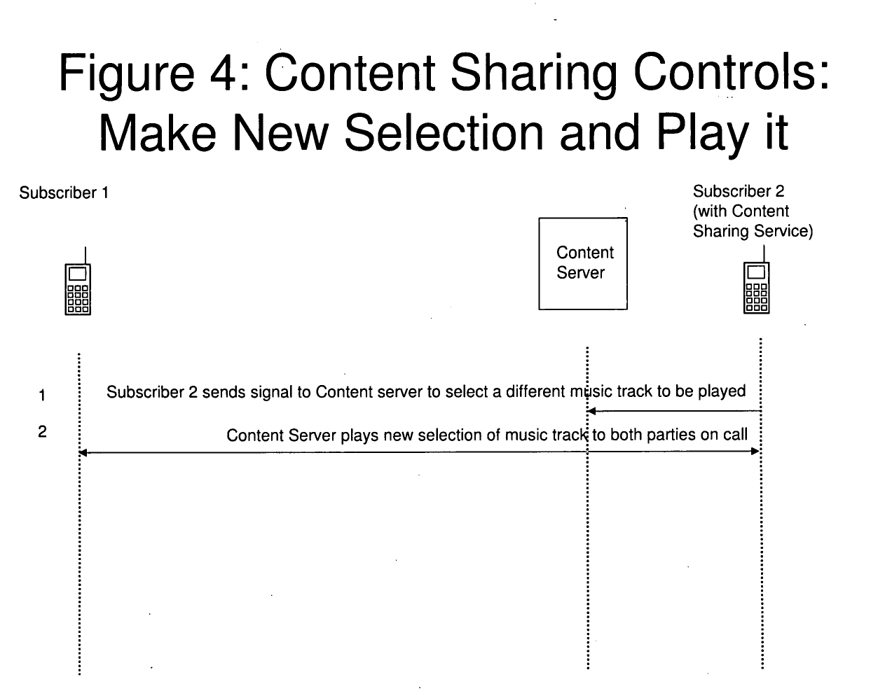

In FIG. 4, the Call Flow begins after the Content Server is playing a music track to both parties on a Content Sharing session. In this scenario, Subscriber 2 has already established a Browser session connected to the Content Server. The example used in FIG. 4 is for audio-only content.
1. Subscriber 2 decides that they want share a different selection of music with Subscriber 1 than the music track which is currently playing. Subscriber 2 uses the Browser on their mobile terminal to browse from the menu provided by the Content Server. Subscriber 2 makes a selection of a new music track to be played.
2. The Content Server stops playing the old music track and begins playing the newly selected music track to both subscribers on the call.

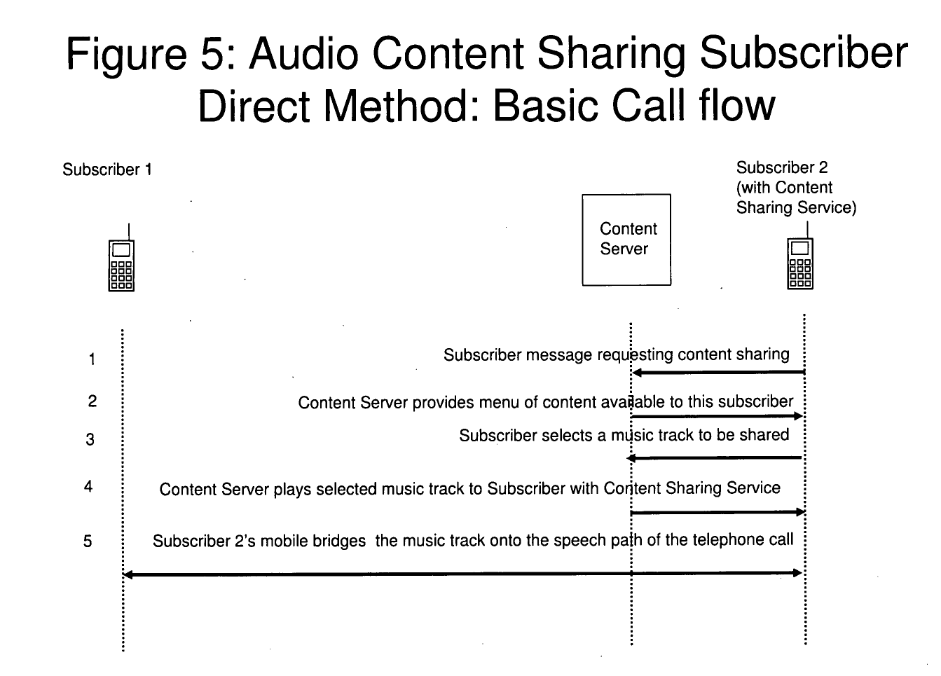

In FIG. 5, a Call flow is shown for the Subscriber Direct method of Content Sharing. In this scenario, the Content Sharing service begins after a telephone call is up in a talking state between two subscribers. The Subscriber Direct method of Content Sharing service does not require any signaling or control by the telephony network. Subscriber 2 has Content Sharing service available to them through a company other than the telephone network operator providing them with telephony service. The Content Sharing service company operates a Content Server which is directly accessible via the Internet by Subscriber 2's mobile terminal. Note that the content used in this example Call flow in FIG. 5, was audio-only content.
1. After Subscriber 1 and Subscriber 2 are in a talking state, Subscriber 2 decides that they want to play a music track on the call. Subscriber 2 makes a connection to the Content Server directly through the Internet. The telephony speech path between Subscriber 1 and Subscriber 2 is unaffected in anyway and the Mobile Switching Center performs no functions associated with Content Sharing for this telephone call.
2. The Content Server accepts the incoming IP connection from Subscriber 2. The Content Server authenticates the service request from Subscriber 2 and provides access to a menu of content based upon the subscriber's specific profile or it provides a generic menu. In this simplest of call scenarios, the subscriber authentication and profile information is maintained within the Content Server itself. These functions could be deployed elsewhere in the Internet Protocol network which would require extra signaling and messages in the call flow to support.
3. Subscriber 2 browses the menu of available music tracks and selects one to be played. This selection is signaled to the Content Server.
4. The Content Server begins playing the selected music over the IP Connection to Subscriber 2.
5. Subscriber 2's mobile terminal bridges the audio from the IP session connected to the Content Server, to the telephone speech path. Effectively, Subscriber 2's mobile terminal is acting as a conference bridge in a Three Way Call. Both Subscriber 2 and Subscriber 1 are now hearing the music being played by the Content Server.

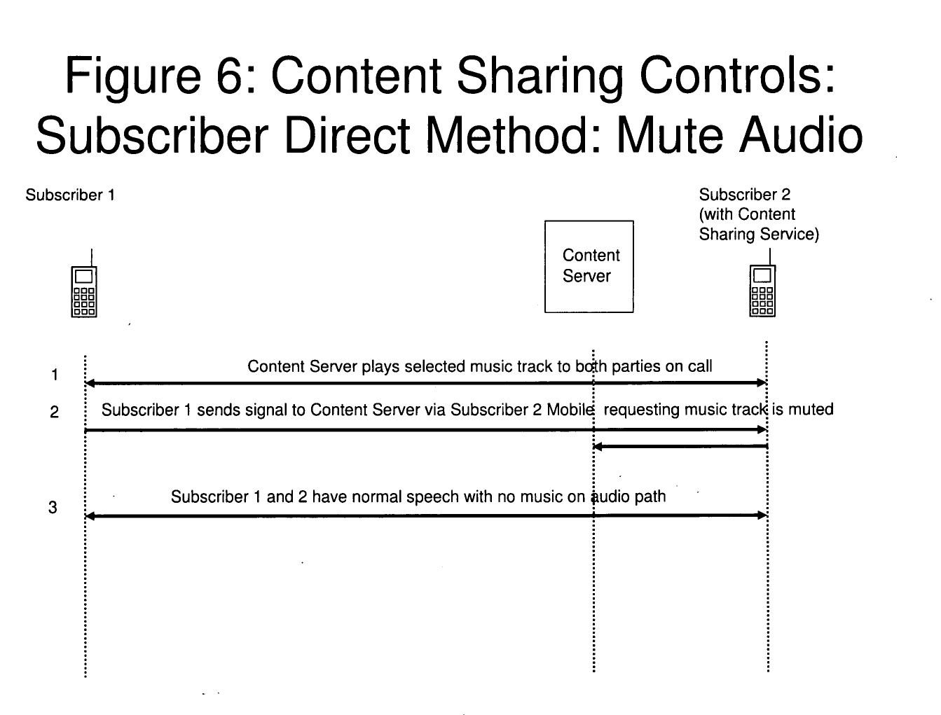

FIG. 6 is a Call flow for Subscriber Direct Content Sharing controls. It shows the Method by which a subscriber in the call, who is not the subscriber with the content sharing service) can mute the audio portion of the content being played. The Call flow in FIG. 6 differs from the Call flow in FIG. 2 because it uses a different method to accomplish the same function of muting the audio playback. The different method of muting the content is required because of the differences between providing Content Sharing via the Subscriber Direct Method versus providing Content Sharing via the Telephony Method.
1. This Call Flow begins after the Content Server is playing a music track to both parties on a telephone call. This Call flow is based upon the Subscriber Direct Method of content sharing.
2. Subscriber 1 decides that they want to talk without hearing music on the call. Subscriber 1 sends a signal in-band on the physical audio path from their handset requesting the Content Server stop playing the audio track. This signal would be particular tone or set of tones (e.g. *77) pre-defined by the Content Server operator. The audio signal is sent from Subscriber 1 through Subscriber 2's terminal onwards to the Content Server. The Content Server is listening for these tones in the audio path and when it detects them (from either party on the call), it responds to them as it has been pre-programmed to do. While this example used Subscriber 1 to send the tones to mute the audio playback of the Content being shared, any subscriber, on the telephone call, has the ability to control the content playback. Note that the audio bridge connection between the Content Server and the subscribers remains up.
   a. It is to be defined by the Content Server operator, whether the music track stops playing or whether it continues playing silently until another signal is received.
3. Subscriber 1 and Subscriber 2 carry on a normal conversation without any music being played on their speech path by the Content Server.

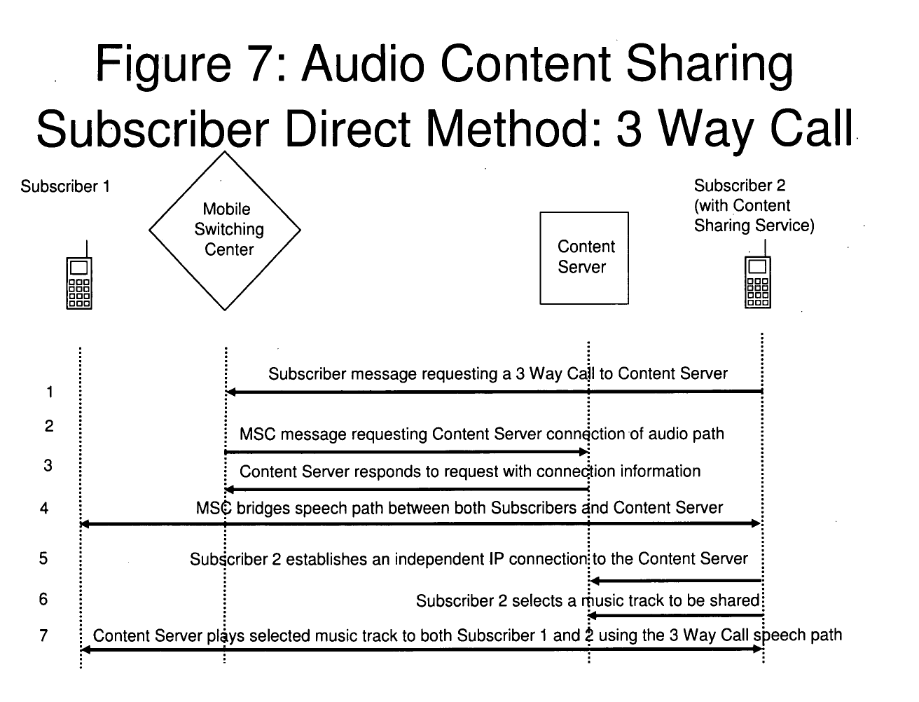

FIG. 7 is a Call flow for another method of providing Subscriber Direct Audio Content Sharing using the Telephony networks Three Way Call feature. It identifies the key elements and method proposed to support the new content sharing service between telephone subscribers who are on a telephone call that is in a talking state. The Call flow in FIG. 7 is different from the Call flow in FIG. 1 and FIG. 5 because it uses a different Method to accomplish the same function of providing a means for subscribers to share content on a telephone call. The Content Sharing call begins after the telephone call is up in a talking state between two subscribers. In this Content Sharing Call Flow, a Mobile Telephony network is displayed where both parties on the call are hosted by the same Mobile Switching Center. The Content Sharing scenario would equally work if the subscribers were on different telephone switches the only difference being extra call signaling and physical speech path set-up between the various telephony network elements involved in the telephone call. In this scenario, the MSC and HLR are not directly involved in providing the Content Sharing service and do not store anything in the subscriber's profile about the Content Sharing feature. From the Telephony network point of view, this call is just a regular Three Way Conference call. The subscriber, with the Content Sharing service, has an independent service arrangement which allows them to access the Content Server directly.
1. After both subscribers are in a talking state, Subscriber 2 decides that they want to play a music track on the call. Subscriber 2 sends a signal from their handset to the Mobile Switching Center requesting a Three Way Call (3 Way Call) to the Content Server.
2. The Mobile Switching Center sends a signal to the Content Server requesting a physical audio path (i.e. using a telephone trunk circuit) to be used to connect from the Content server to the MSC. From the MSC point of view this is a Three Way Call between Subscriber 1 and Subscriber 2 and the Content Server.
3. The Content Server replies to the MSC's connection request by providing a physical audio path connection via a telephony trunk circuit.
4. The MSC uses an audio conferencing resource to bridge the Content Server physical audio path to the physical audio path already being used for speech between the two subscribers. This is effectively a Three Way Call between the Content Server, the Subscriber 1 and the Subscriber 2.
5. Subscriber 2 establishes an Internet Connection directly with the Content Server. The Content Server authenticates Subscriber 2's Content Sharing service request and provides Subscriber 2 with a menu of available content.
6. In this example call flow, a Browser on Subscriber 2's mobile terminal is used to select a music track from a menu on the Content Server. The Three-Way telephone call and mobile telephone equipped with an Internet Protocol capable web browser supported over a wireless data connection are existing technologies deployed in the marketplace today. What is new is using this capability to support the sharing of content such as music.
7. The Content Server plays the selected music track on the Three Way Call telephone connection between Subscriber 1 and Subscriber 2 and the Content Server.

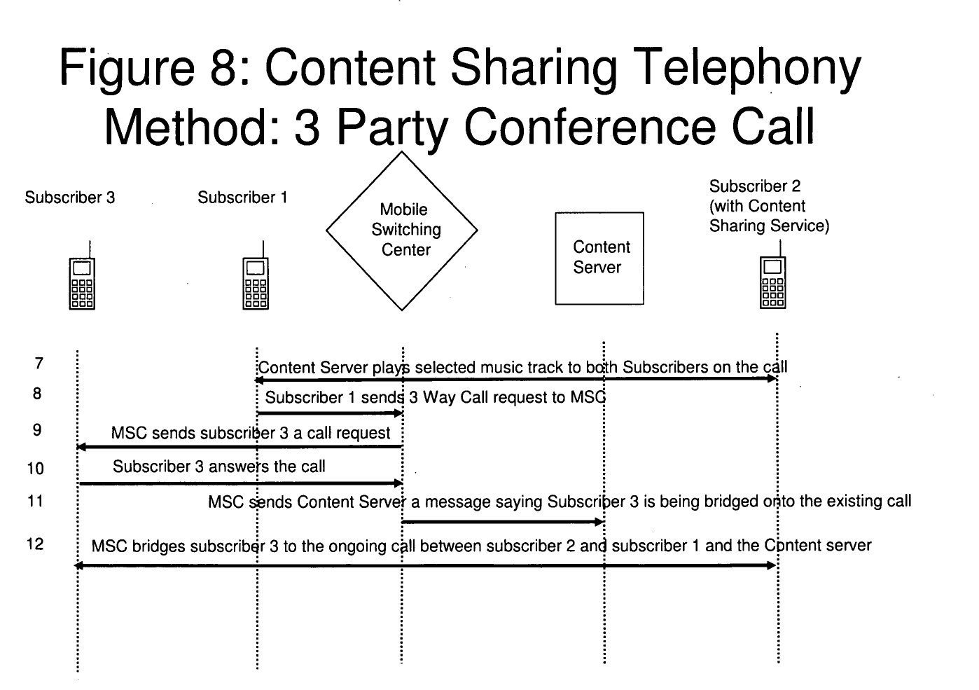

FIG. 8 is a Call flow based upon the Telephony Method of Content Sharing with more than two subscribers. It starts after step 7 in FIG. 1. This is a variation of the Content Sharing service which is caused by the bridging on of another party to the telephone call which is already up in a Content Sharing session. The Call flow shows the Method for providing Content Sharing to a third subscriber added to the existing telephone call between Subscribers 1 and 2. This scenario begins after Step 7 in FIG. 1. Both Subscriber 1 and Subscriber 2 are listening to music being played by the Content Server.
7. The Content Server is playing the selected music track on the physical audio path connection and both Subscriber 1 and Subscriber 2 are sharing the music on their telephone call. This is a repeat of Step 7 from FIG. 1 to provide the necessary context.
8. Subscriber 1 decides to Three Way Call Subscriber 3 and bridge them onto the telephone call with Subscriber 2. Subscriber 1's terminal sends the information requesting the Three Way Call to the MSC. For this example, Subscriber 1 Three Way Called Subscriber 3 but the method would equally work if Subscriber 2 was the one to Three Way Call Subscriber 3.
9. The MSC processes the Three Way Call request from Subscriber 1 and in this simple scenario Subscriber 3 is being served by the same MSC as Subscriber 1 and Subscriber 2. Note that this scenario would work equally well if Subscriber 3 was hosted on a different telephone switch. In this event it would require additional signaling between the MSC and whatever other telephone network nodes were required to support the telephone call.
10. Subscriber 3 answers the incoming call from Subscriber 1.
11. The MSC sends a message to the Content Server informing the Server that Subscriber 3 has been added to the call. The information would include the telephone number of Subscriber 3 which the Content Server requires for its record keeping. The Content Server is responsible for tracking content usage by user so it needs to know every party connected to the telephone call.
12. The MSC uses an audio conferencing resource to bridge Subscriber 3 to the ongoing telephone call between Subscriber 1 and subscriber 2 and the Content server. This call has now become effectively a 4 Party Conference Call with the addition of music being shared by three of the parties on the active call. Note that this dissimilar from music being played on an audio conference bridge while the parties on the call are on hold. In our invention, the parties on the call are in an active talking state on the call. They are also capable of directly controlling the music selection and playback while on the call.

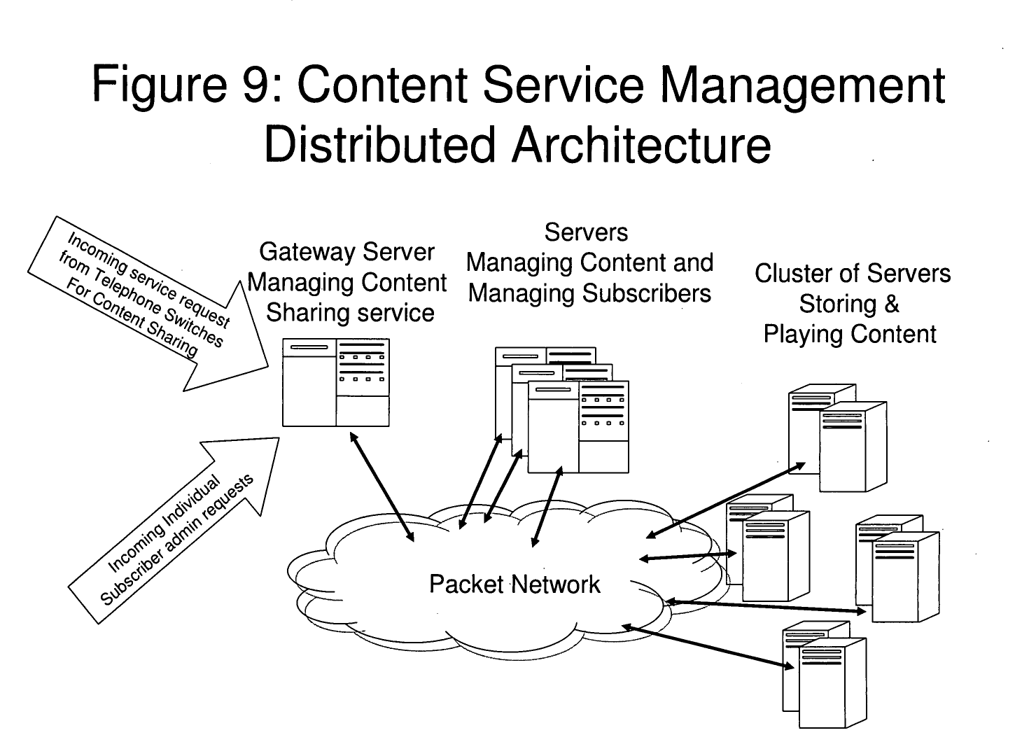

FIG. 9 is a network diagram of a Content Service architecture designed to support a large number of transactions expected of a telephony network in a large urban region. The functions required to be performed by the Content Service would be distributed across multiple servers so as to provide the necessary capacity and redundancy required to support a telephone network with more than 1 million subscribers. The Content Service would likely be distributed into various functional nodes connected over a packet based network. The two drivers behind this distributed architecture are:

a. The scale required to support Content Sharing in a telephony network with millions of subscribers.

b. The reliability of the Content Sharing service which needs to meet telephony standards (e.g. 99.999% availability per year). Redundant nodes performing critical functions help provide the necessary reliability.

The key functional Components are:

a. A Content Storage and Playback Server whose function is to store the audio only, audio-visual and visual only content for playback upon the direction of the Content Management Server.

b. A Content Management and Subscriber Management Server. These Servers manage and store the subscriber's individual menus and their Content Sharing service options. The Servers also manage the content that is stored and played. The Servers are responsible for generating and storing user records of what content was played to whom and when.
i. The Server tracks and stores content usage information by user. Specific information includes:
   Which Subscriber shared content with which other subscribers. This includes information about all subscribers on the Content Sharing session, not just the Content Sharing service Subscribers information. Note more that two subscribers may be on the call in which case the information on all the subscribers, on the conference call, will be recorded and stored.
   What content was shared by session including sessions where multiple pieces of content where shared.
   When the content was shared.
   How long the content was shared.
ii. A Gateway Content Server manages the work distribution amongst incoming Content Sharing service requests. Note that Content Sharing service requests include actual service requests from the telephony network as well as administrative type requests by individual subscribers managing their Content Sharing service options while not actually in an active call.

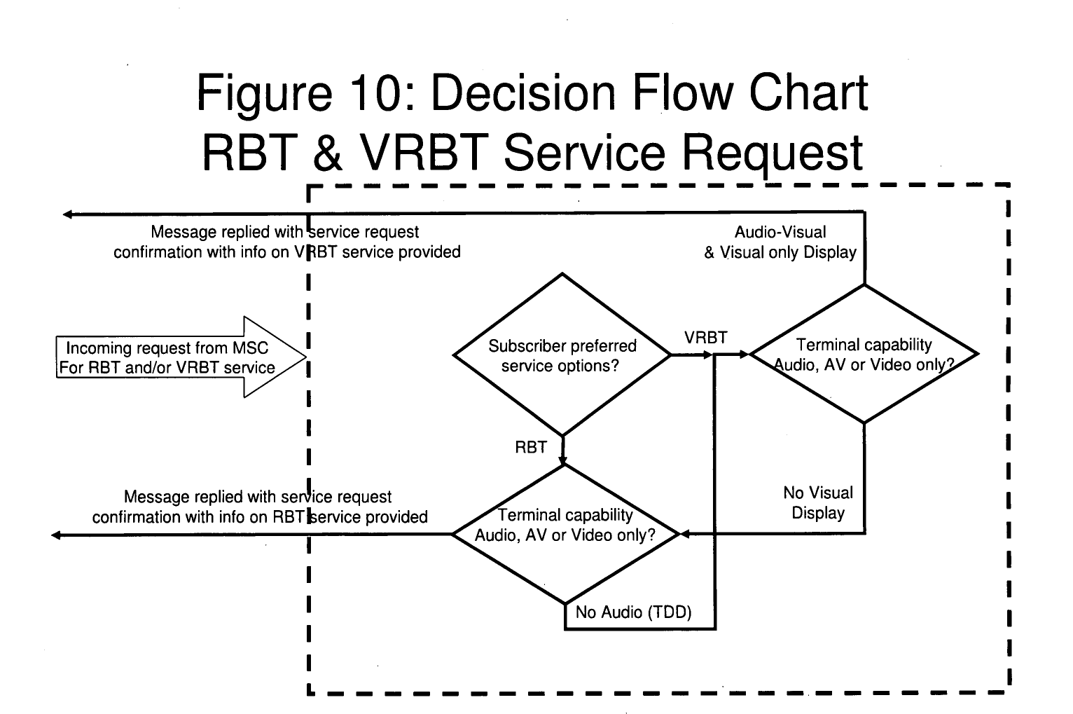

FIG. 10 is Decision Flow chart is for the Ring-Back Tone Server receiving a request for service from a telephone switch. The service provided could be either Ring-Back Tone (RBT) service and/or Video Ring-Back Tone (VRBT) service. It identifies the key decision points and logic flow performed by the Ring-Back Tone Server in the Telephony Method. The decision flow chart starts after the Ring-Back Tone Server has received an incoming service request from a telephone switch to provide Ring-Back Tones or Video Ring-Back Tones service. Every function which occurs within the dotted lines is part of the Ring-Back Tone Server's responsibility.

a. The first thing that needs to be decided by the Ring-Back Tone Server handling the request is the service option preferences for the individual subscriber who has the RBT, VRBT or both options available.
The typical priority would be to provide VRBT over RBT where possible.

b. Once the decision has been made to provide RBT or VRBT service, then the second decision needs to be made on whether the preferred service can be provided on the call request based upon the Calling party's terminal capabilities. The information on the terminal capabilities of the Calling party is provided by the Telephone Switching center controlling the RBT and VRBT Service.
The Calling party terminal might have no visual capability (e.g. a typical Wireline telephone), in which case VRBT can not be offered. It is expected (but not mandatory), that RBT service would be provided in lieu of VRBT in this scenario.
If the Calling party was on a TDD terminal, then RBT would not provided. It is expected (but not mandatory), that Visual Only VRBT service would be offered in lieu of RBT in this scenario.

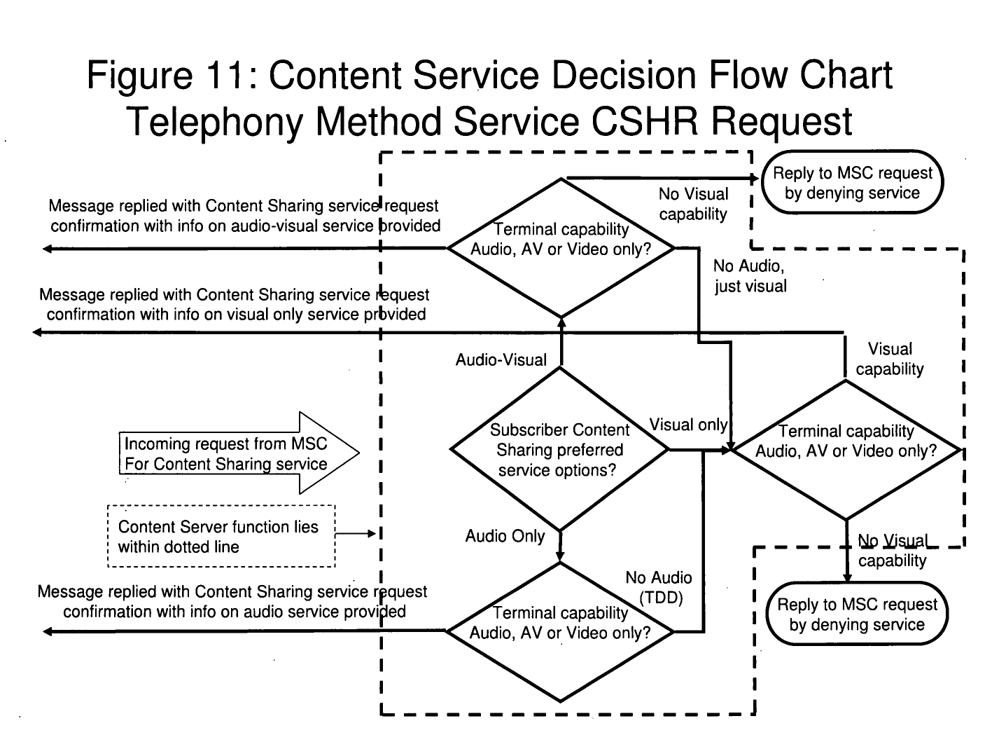

FIG. 11 is Decision Flow chart for the Content Server providing service to the telephone switch. It identifies the key decision points and logic flow performed by the Content Server to establish a Content Sharing service in the Telephony Method. The decision flow chart starts after the Content Server has received an incoming service request from a telephone switch to provide Content Sharing service. The call is already in a talking state. Every function which occurs within the dotted lines is part of the Content Server's responsibility.

In the Telephony method, the Subscriber to the Content Sharing service is authenticated by the Telephony network. In a Mobile Telephony network, the Content Sharing Subscriber's profile would contain the feature information that the Subscriber is allowed to access the Content Service. In a Wireline Telephony network, the Content Sharing service would be another vertical telephony feature (like Three Way Calling) and datafilled against that subscriber's telephone number in the host telephone switching office. The telephone switch (either Wireline or Wireless) begins the Content Sharing service by sending a message to the Content Server that requests service for the particular subscriber. The Content Sharing Service request contains:
i. It specifies the type of physical connection requested. It specifies whether the connection will be audio only as in a regular telephone speech path or audio-visual as in a video telephony call or video only.
ii. It specifies the subscriber terminal capabilities for all subscribers on the telephone call in regards to receiving audio, audio-visual or visual only content. Note that some mobile telephony terminals are capable of receiving audio-visual messages but are not necessarily providing an actual video telephony call. For example: Terminal Devices for the Deaf (TDD) do not receive audio.
iii. It contains Information about the Subscriber requesting service as well as information on the other Subscriber on the call with whom the Content will be shared. Specifically, the subscriber's telephone numbers are required by the Content Server to enable tracking of content usage by user.
iv. It contains connection information required to establish a physical path between the Content Server and the Subscribers in the telephone call.

The operator of the Content Service could chose to limit the service under certain conditions based upon their own policies. Possible CSHR restrictions could include:
i. Not providing CSHR on a conference call that had more than 3 subscribers on it. This might simplify content management from the content provider point of view.
ii. Not providing CSHR service if any of the parties on the telephone call can not be identified to the Content Server.
iii. It is rare but possible, even in modern telephony networks, to find a telephone call where one of the parties is not known to the other (if the call went through an old Per Trunk Signaling type trunk that does not support Calling Party Identification).
iv. Re-negotiating the type of service to be provided when another party is bridged onto the call if their terminal had lesser capability than the other two parties currently sharing content. For example, say the first two parties were sharing a music video track and then one of them bridged on another subscriber whose terminal was only capable of audio. It might be desirable to provide audio only to all three players sharing the content. Alternatively, the audio-visual Music Video could be shared between the first two subscribers while the audio-only portion of the same Music Video would be heard by the third party.
v. There are a variety of terminal types with differing capabilities. Telco operator could chose to set some system level defaults to simplify the content display type decision.
vi. Assume that all mobile terminals are AV capable.
vii. Assume all Wireline terminals are only capable of supporting audio.
viii. Assume all VoIP terminals are AV capable

The first thing that needs to be decided by the Content Server, serving the Content Sharing (CSHR) service request, is the service option preferences for the individual subscriber who has the CSHR service. There are three choices available:
i. Audio-Visual. The expected default service would be for Audio-Visual service where possible.
ii. Visual-only. Note that the hearing impaired subscribers might have a Visual-only preference.
iii. Audio-only. Note that the visually impaired subscribers might have an Audio-only preference.

The next decision that gets made is based upon the terminal capabilities of all the parties on the call. The telephone switching center provides the terminal capability information for all parties on the CSHR call (if this is a 3 party conference call, for example).
i. If the Calling party was on a TDD terminal, then audio only or audio-visual content would not shared. It is expected (but not mandatory), that Visual-Only CSHR service would be offered in this scenario.
ii. The Calling party terminal might have no visual capability (e.g. a typical Wireline telephone), in which case Visual-only or audio-visual content can not be shared. It is expected (but not mandatory), that audio only CSHR service would be provided in this scenario.

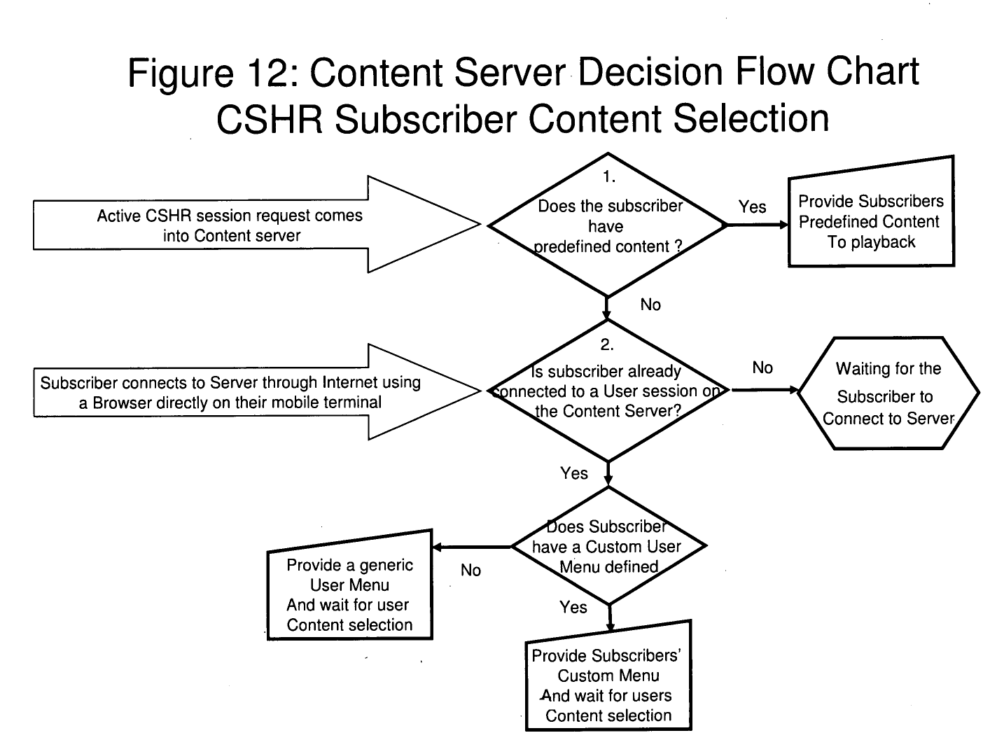

FIG. 12 is a Decision flow chart for the Content Server to provide content options to a Subscriber. It identifies the key decision points and logic flow performed by the Content Server to provide a menu of content to be played to the subscriber of the Content Sharing service. Having decided to provide Content Sharing service as requested for a subscriber and the parties that they are connected to, the next set of decisions revolve around what content to provide to the subscriber of the CSHR service. There will a couple of options that could implemented by the operator of the Content Sharing service. The actual service implementation would be at the Content Sharing service operator's discretion.

The Subscriber could chose to have a daily content selection of audio-only content, audio-visual content or visual-only content. This pre-selected subscriber content would be provided automatically upon the subscriber requesting the CSHR service. The Subscriber could chose to access a menu of the Content Sharing server and make a selection in real-time to be shared with the other parties on the telephone call. This is shown in FIG. 12.
i. The Menu provided to the subscriber could a customized menu tailored by the subscriber or it could a generic type menu provided by the Content server operator based upon popular choices my other subscribers.
ii. The Content Server could provide a Menu to the Subscriber based upon the limits of the connection and terminal display capabilities. For example, an audio only connection would cause the Content Server to present an audio only content menu to the Subscriber making the content selection.

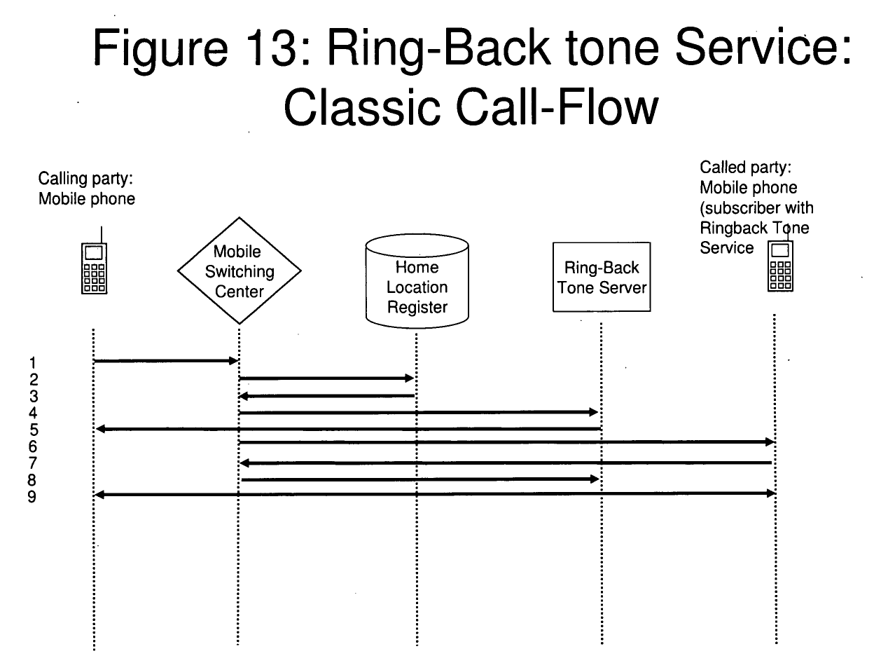

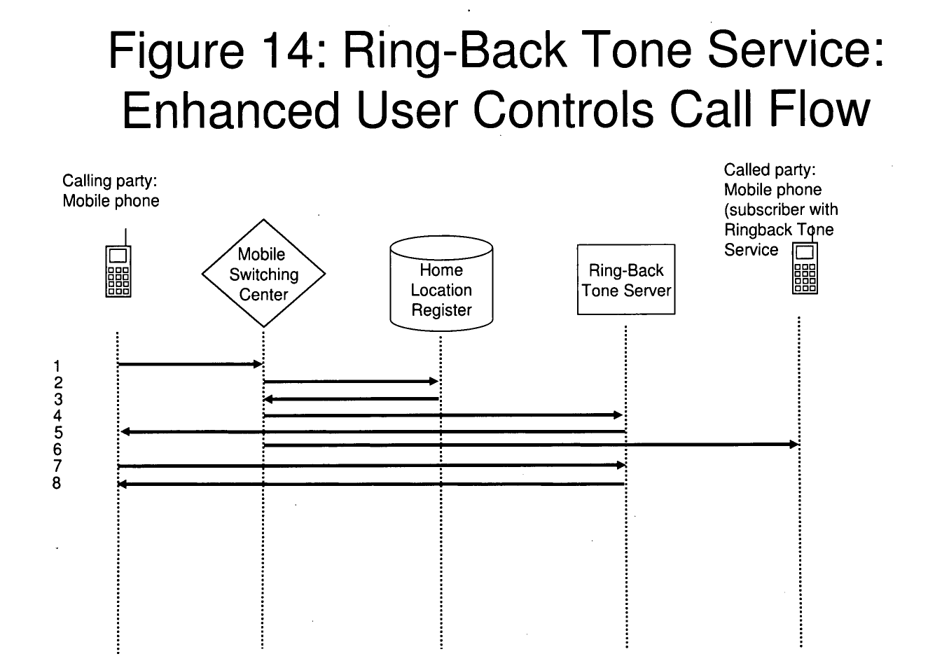

In FIG. 13, a classic Ring-Back Tone Call flow is shown for the purposes of illustrating the enhancements in FIG. 14. No invention is being claimed in this Patent specification for FIG. 13. The Ring-Back Tone Service Call flow is also described in the US Patent Application 20050207555 September 2005, Lee et al. METHOD AND APPARATUS FOR MANAGING PRESENTING AND CHANGING RING-BACK SOUNDS IN SUBSCRIBER-BASED RING-BACK SOUND SERVICE.
1. A Calling party with a mobile phone dials a called party mobile phone where both mobile telephones are currently on a Mobile Switching Centre (MSC). In this scenario, the Called Party is a mobile telephony subscriber who has the Ring-Back Tone service. This generates a call setup request from the calling party to the Mobile Switching Center. The Mobile Switching Center begins to process the mobile telephone call.
2. The Mobile Switching Centre will generate a message to a Home Location Register (HLR) where the Called party's subscriber profile is kept.
3. The Home Location Register stores the Called party's profile. The profile includes information about features which are supported for that individual subscriber. In this call scenario, one feature is the Ring-Back Tone service. This Called party's profile information, which includes that necessary to support Ring-Back Tone service, is sent back to the Mobile Switching Centre.
4. The Mobile Switching Centre receives the message from the Home Location Register with the Called party's profile and this information is used to continue processing the call. In step 4, the Mobile Switching Centre is sending a message to a Ring-Back Tone Server to provide the Ring-Back Tone service for this call. The message sent to the Ring-Back Tone server by the MSC would include the facilities required to establish a physical audio path (using a telephony trunk circuit) between the Ring-Back Tone Server and the MSC and the Calling party.
5. The Ring-Back Tone Server plays a specific Ring-Back Tone to the Calling party. The Ring-Back Tone played to the Calling party would be that predefined by the Called party as part of their setting up the Ring-Back Tone service. The Calling Party Mobile telephone is receiving the Ring-Back Tone and the Calling party user is presumably listening to it while waiting for the Called party to answer the telephone call.
6. Parallel in time to the Ring-Back Tone Server playing to the Calling Party, the Mobile Switching Center is also paging the Called party Mobile telephone. This alerts the Called party that they have an incoming call.
7. In this scenario, the Called party chooses to answer the call. This sends a message to the Mobile Switching Center.
8. The Mobile Switching Center tears down the audio path connecting from the Calling party to the Ring-Back Tone Server. The audio playback session on the RingBack Server is terminated.
9. The Mobile Switching Center then establishes a speech path between the Calling party and the Called party for the voice conversation portion of this telephone call.

In FIG. 14, an enhanced Ring-Back Tone Call flow is shown where the Calling party is provided with a means of controlling the Ring-Back Tone playback. This method of providing a means to control the playback of the Ring-Back Tones is new to Ring-Back Tone service.
1. A Calling party with a mobile phone dials a called party mobile phone where both mobile telephones are currently on the same Mobile Switching Centre. This generates a call setup request from the calling party to a Mobile Switching Center. The Mobile Switching Center begins to process the mobile telephone call.
2. The Mobile Switching Centre will generate a message to a Home Location Register where the called party's profile is kept.
3. The Home Location Register stores the called party's user profile. The users profile includes information about features which are supported for that individual subscriber. In this call scenario, one feature is the Ring-Back Tone service. This users profile information, which includes that necessary to support Ring-Back Tone service, is sent back to the Mobile Switching Centre.
4. The Mobile Switching Centre receives the message from the Home Location Register with the users profile and this information is used to continue processing the call. In step 4, the Mobile Switching Centre is sending a message to a Ring-Back Tone Server to provide the Ring-Back Tone service for this call.
5. The Ring-Back Tone Server plays a specific Ringback Tone audio track. The audio track would be that predefined by the Called party as part of their setting up the Ring-Back Tone service. The Ring-Back Tone Server connects through the mobile telephony network to the Calling Party Mobile via an audio speech path. The Calling Party Mobile telephone is receiving the audio track and the Calling party user is presumably listening to it while waiting for the Called party to answer the telephone call.
6. Parallel in time to the Ring-Back Tone server playing the audio track to Calling Party, the Mobile Switching Center is also paging the Called party Mobile Telephone. This alerts the Called party that they have an incoming call. Note that in a mobile telephony network, the delay between the Called party mobile being paged and then answering the call is typically more than 7 seconds. This time interval is used to play the audio track from the Ring-Back Tone Server to the Calling Party
7. The Calling party decides they do not want to listen to the audio track being played by the Ring-Back Tone server. They signal the Ring-Back Tone Server using tones generated from the digitone keypad on their telephone terminal to discontinue playing. This is the enhancement to Ring-Back Tone service.
8. In this scenario it is the Ring-Back Tone Server which is listening for a certain set of pre-programmed tones on the audio path. The playback of the specified Ring-Back Tones is terminated and normal audible ringing is provided by the Ring-Back Tone Server in its place. The telephone call itself continues until the Called party answers the incoming call or the call otherwise gets treated.
   Alternatively, the MSC could be programmed to listen for these tones from the Calling party receiving Ring-Back Tones. When the MSC receives this signal from the Calling party, it would terminate the Ring-Back Tone service and switch back to normal audible ringing tones until the telephone call was answered or otherwise treated.

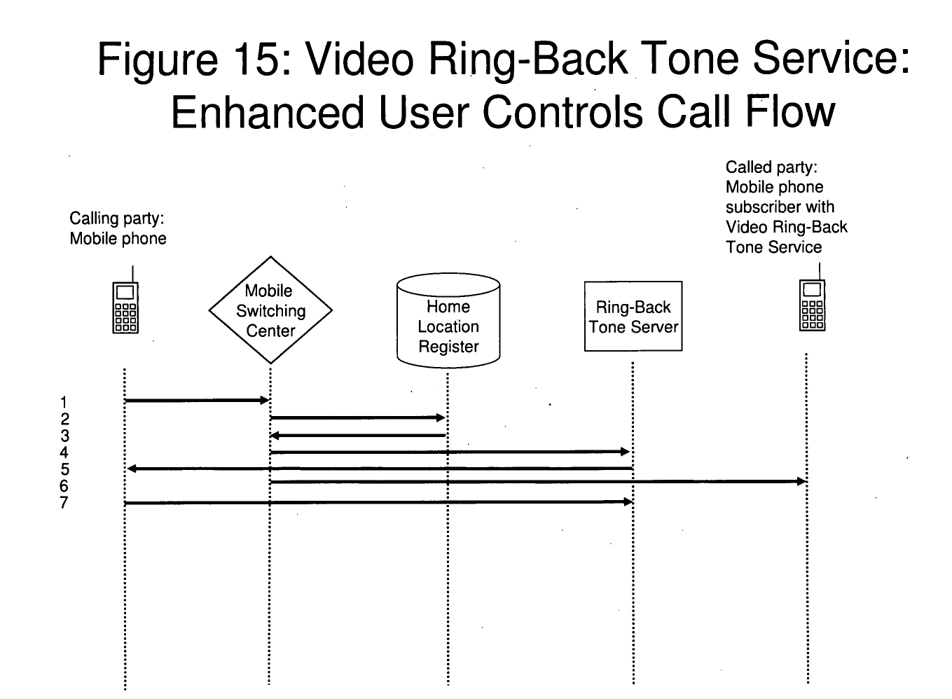

In FIG. 15, an enhanced Video Ring-Back Tone Call flow is shown where the Calling party is provided with a means of muting the Video Ring-Back Tone playback. This method of providing a means to control the playback of the Video Ring-Back Tones is new to Video Ring-Back Tone service.
1. A Calling party with a mobile phone dials a called party mobile phone where both mobile telephones are currently on the same Mobile Switching Centre. This generates a call setup request from the Calling party to a Mobile Switching Center. The Mobile Switching Center begins to process the mobile telephone call.
2. The Mobile Switching Centre will generate a message to a Home Location Register where the Called party's profile is kept.
3. The Home Location Register stores the Called party's user profile. The users profile includes information about features which are supported for that individual subscriber. In this call scenario, one feature is the Video Ring-Back Tone service. The Called party's profile, which includes that information necessary to support Video Ring-Back Tone service, is sent back to the Mobile Switching Centre.
4. The Mobile Switching Centre receives the message from the Home Location Register with the users profile and this information is used to continue processing the call. In step 4, the Mobile Switching Centre is sending a message to a Ring-Back Tone Server to provide the Video Ring-Back Tone service for this call.
5. The Ring-Back Tone Server plays a specific Video Ring-Back Tone. The Video Ring-Back Tone would be an audio-visual track that was predefined by the Called party as part of their setting up the Video Ring-Back Tone service. The Ring-Back Tone Server connects through the mobile telephony network to the Calling Party Mobile via an audio speech path.
6. Parallel in time to the Ring-Back Tone Server playing the audio-visual track to Calling Party, the Mobile Switching Center is also paging the Called party Mobile Telephone. This alerts the Called party that they have an incoming call. Up to this point in the call flow sequence, it is existing art.
7. The Calling party decides they do not want to listen to the audio portion of the Video-Ring-Back Tone track being played by the Ring-Back Tone server. They signal the Ring-Back Tone Server, using tones, to mute the audio portion. The Visual portion of the audio-visual Ring-Back Tone continues to play. This is the enhancement to Video Ring-Back Tone service. The Video Ring-Back Tone Server is listening for a set of predefined tones on the audio path. The playback of the specified Video Ring-Back Tone is muted when the Calling party sends the predefined tones. The Video portion of the Ring-Back Tone continues to play until the Called party answers the incoming call or the call otherwise gets treated.

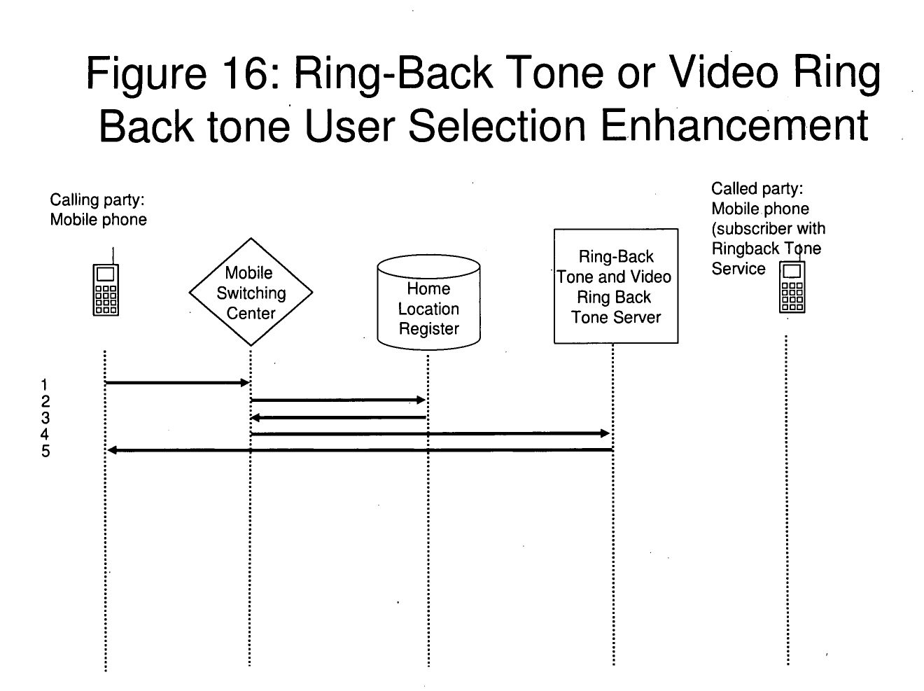

In FIG. 16, an enhanced user selection mechanism is shown for Ring-Back Tone or Video Ring-Back Tone service.
1. A Calling party with a mobile phone dials a Called Party mobile phone where both mobile telephones are currently on a Mobile Switching Centre (MSC). In this scenario, the Called Party is a mobile telephony subscriber who has the combined Ring-Back Tone and Video Ring-Back Tone service options. This generates a call setup request from the calling party to the Mobile Switching Center. The Mobile Switching Center begins to process the mobile telephone call.
2. The Mobile Switching Centre will generate a message to a Home Location Register (HLR) where the Called party's subscriber profile is kept.
3. The Home Location Register stores the Called party's profile. The profile includes information about features which are supported for that individual subscriber. In this call scenario, two features supported by the Callers profile include both the Ring-Back Tone service and Video Ring-Back Tone service options. This Called party's profile information is sent back to the Mobile Switching Centre. The Mobile Switching Centre receives the message from the Home Location Register with the Called party's profile and this information is used to continue processing the call.
4. In step 4, the Mobile Switching Centre is sending a message to a combined Ring-Back Tone and Video Ring-Back Tone Server to provide the service for this call. The message sent from the MSC includes the Calling party mobile terminal device capabilities: specifically information that allows the Ring-Back Tone and Video Ring-Back Tone Server to determine if the Calling party can support any video capability. The message sent to the Ring-Back Tone server by the MSC would also include the facilities required to establish a physical audio path (using a telephony trunk circuit) between the Ring-Back Tone Server and the MSC and the Calling party as well as the data session facilities necessary (e.g. IP address for Calling party) to support delivery of Audio-Visual or Visual only content.
5. The Ring-Back Tone and Video Ring-Back Tone Server makes a decision on what content to play based upon the Calling party terminal device capabilities (i.e. does it support Visual content or just audio?), the Called party predefined content selection and the Called party service preferences (e.g. if supported by Calling party terminal, then play Audio-Visual content in preference to audio-only content). The Ring-Back Tone, played to the Calling party, would be that predefined by the Called party as part of their set-up and administration of the Ring-Back Tone and Video Ring-Back Tone service. The Calling Party Mobile telephone is receiving the Ring-Back Tone or Video Ring Back Tone and the Calling party user is presumably listening to it and or watching it while waiting for the Called party to answer the telephone call.

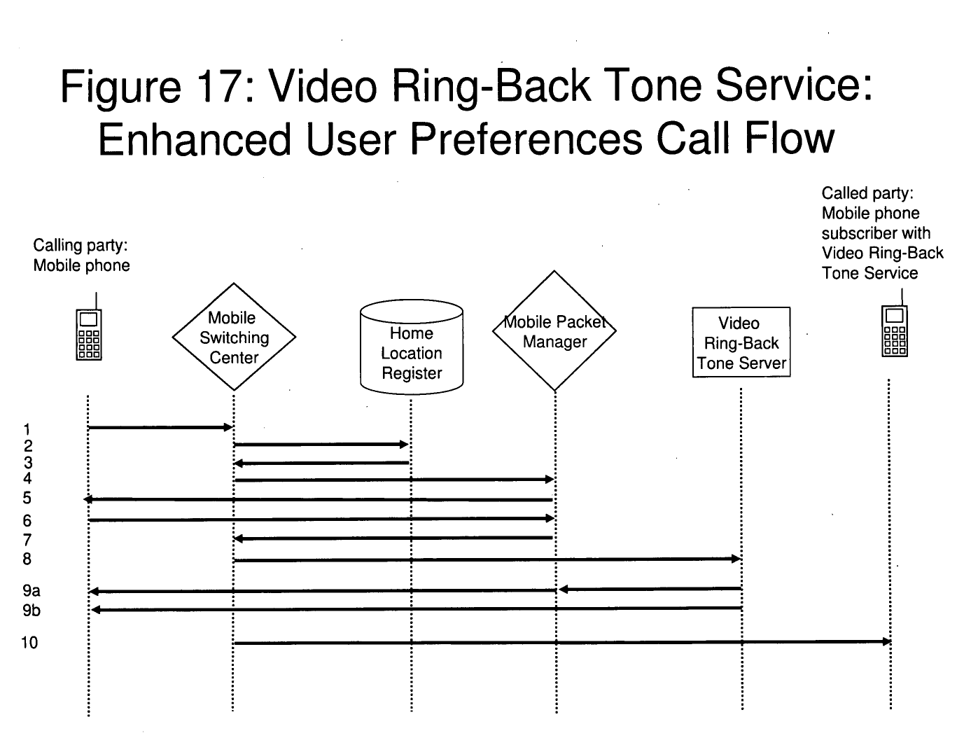

In FIG. 17, an enhanced user preferences call flow is shown for Video Ring-Back Tone service. While Video Ring-Back feature is an already existing telephony feature defined in International telecommunications standards, the enhancement proposed is new.
1. A Calling party with a mobile phone dials a called party mobile phone where both mobile telephones are currently on the same Mobile Switching Centre. This generates a call setup request from the Calling party to a Mobile Switching Center. The Mobile Switching Center begins to process the mobile telephone call.
2. The Mobile Switching Centre will generate a message to a Home Location Register where the Called party's profile is kept.
3. The Home Location Register stores the Called party's user profile. The users profile includes information about features which are supported for that individual subscriber. In this call scenario, one feature is the Video Ring-Back Tone service. The Called party's profile, which includes that information necessary to support Video Ring-Back Tone service, is sent back to the Mobile Switching Centre.
4. The Mobile switching Center receives the message from the Home Location Register with the users profile and this information is used to continue processing the call. Because the Called party has Video Ring Back Tone service, the MSC needs to initiate a data session to the Calling party terminal to support the delivery of audio-visual or visual only content independent of the audio only speech path. If the Calling party terminal has no data capability, then no data session will be established and the Video Ring Back Tone server will be notified by the information sent on the calling party terminal capabilities. If the Calling party terminal can support a data session, then one will be established through the existing mobile telephony packet data network. This is the enhancement to the standards based Video Ring-Back feature. Specifically, the selection of the type of Ring-Back service to be played back to the Calling party based upon the Calling parties terminal capabilities as well as telephone network operator policies and predefined Called party preferences. The MSC would trigger a mobile packet data session by sending a message to the mobile packet data manager. The mobile packet data management function exists in live mobile telephony networks that are operating on various different telecommunications standards.
5. The Mobile packet manager would initiate a data session to the Calling party terminal. This will first require assigning a unique data address (e.g. Domain Name System assignment of temporary Internet Protocol Address) and a then establishing an active data session or dormant data session over the Radio Access Network facilities to the Calling party terminal.
6. The Calling Party mobile responds to the request from the Mobile packet manager to establish an active or passive data session.
7. The Mobile Packet Manager then informs the Mobile Switching Center that it has successfully established a data session to the Calling party terminal and the unique packet data address of the Calling party terminal is provided. The unique data session address will be included in the information onto the Video Ring-Back Server as part of Mobile Switching Center request to establish the Video Ring Back session.
8. The Mobile Switching Centre is sending a message to a Video Ring-Back Tone Server to provide the Video Ring-Back Tone service for this call.
9. The Ring-Back Tone Server plays a specific Video Ring-Back Tone. The Video Ring-Back Tone could be an audio-visual track that was predefined by the Called party as part of their setting up the Video Ring-Back Tone service.
   a. In 9a, the visual content, and audio-visual content is delivered to the Calling party terminal via the data session.
   b. In 9b, the Audio only content could be delivered either through an audio speech path identical to Ring Back Tone or alternatively it could be delivered through the data session. The content delivery of audio-only over a speech path and visual content only over the data session could be simultaneous at the Video Ring-Back Tone Service provider's choice.
10. Parallel in time to the Ring-Back Tone Server playing the audio-visual track to Calling Party, the Mobile Switching Center is also paging the Called party mobile telephone. This alerts the Called party that they have an incoming call.

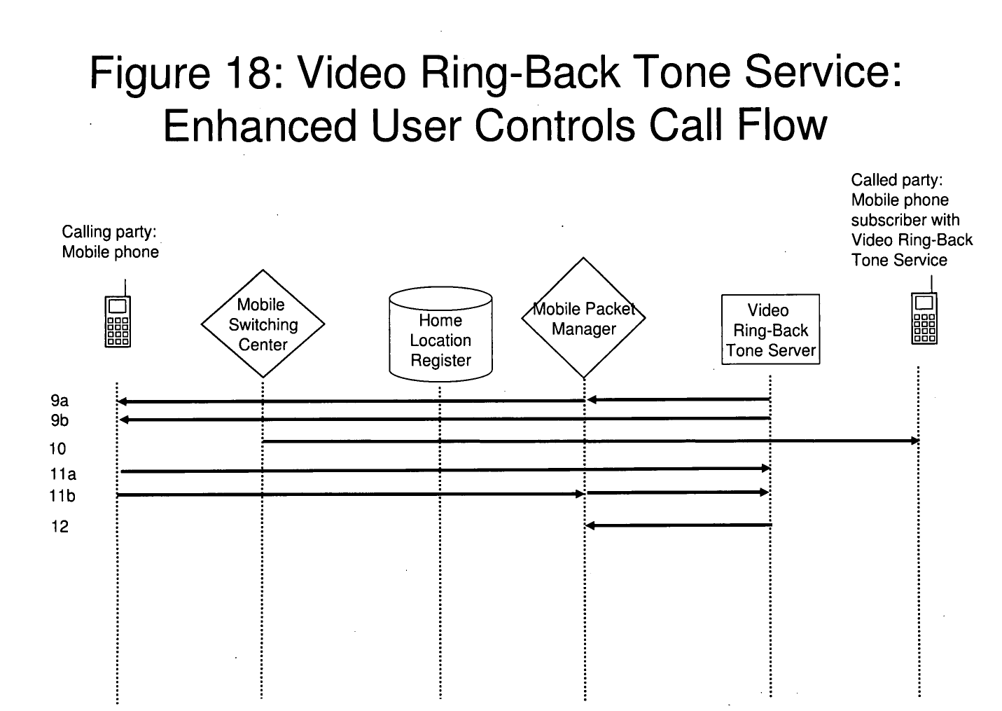

In FIG. 18, this call scenario picks up in sequence after the Video Ring Back Tone is playing the audio-visual, visual and or audio only content to the Calling party. In the previous FIG. 17 this corresponds to steps 9a and/or 9b since these steps can take place simultaneously.
9. The Video Ring-Back Tone could be an audio-visual track that was predefined by the Called party as part of their setting up the Video Ring-Back Tone service. In 9a, the visual content, and audio-visual content is delivered to the Calling party terminal via the data session. In 9b, the Audio only content could be delivered either through an audio speech path identical to Ring Back Tone or alternatively it could be delivered through the data session. The content delivery of audio-only over a speech path and visual content only over the data session could be simultaneous at the Video Ring-Back Tone Service provider's choice.
10. In the continuation of the call flow from FIG. 17, parallel in time to the Ring-Back Tone Server playing the audio-visual track to Calling Party, the Mobile Switching Center is also paging the Called party mobile telephone. This alerts the Called party that they have an incoming call.
11. The Calling party uses the new facility, defined by this patent, to control the playback of the content from the Video Ring Back server. The playback control options available to the Calling party include muting the audio on the playback as well as stopping the playback altogether until the call completes to the Called party or goes to network provided treatment such as an announcement or voicemail facility. In this step, the Calling party signals the Video Ring Back Tone server playing the content to halt playback.
   a. The signaling mechanism used can be either in-band signaling on the two way speech path shown as 11a
   b. Or through a predefined signal sent through the packet data network shown as 11b. The Video Ring Back Tone responds to the control signal sent by the Calling party and halts playback of the content.
12. This step is optional based upon the network operator implementation. The Video Ring Back Server sends a message to the Mobile packet manager informing it that the data session is no longer active, so it is set back to inactive but is not disconnected at this time. This same mechanism could be achieved through a timer expiring on the active data session that would set the session to inactive (a.k.a. dormant).

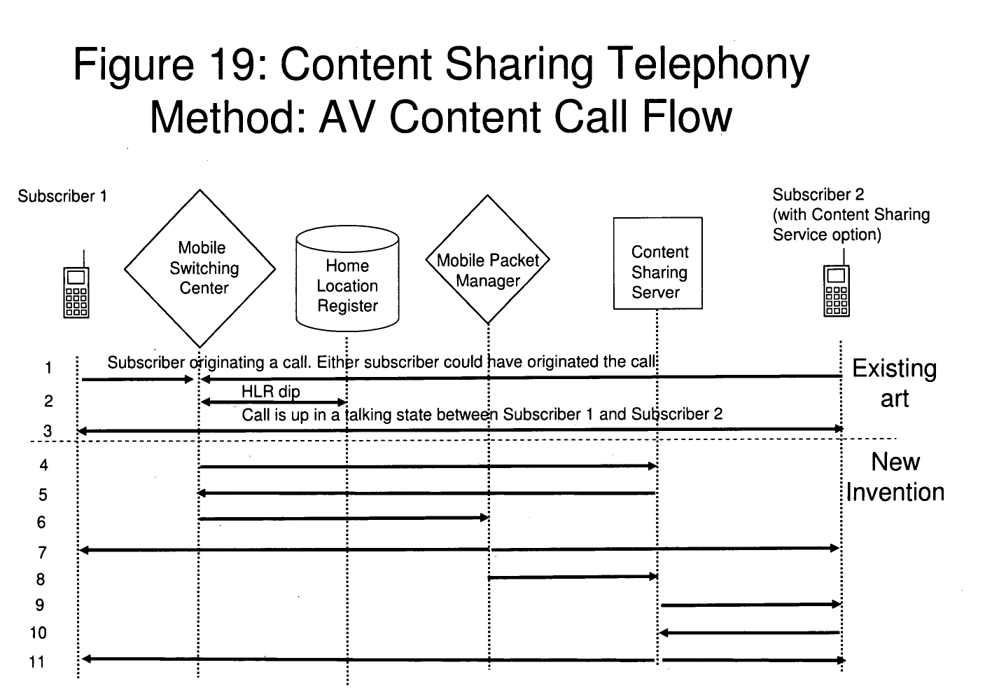

In FIG. 19, a call flow that is similar to the basic call flow shown in FIG. 1 with the difference that the content being shared between the parties on the call is Audio-Visual content. In the telephony system, audio content can be delivered in-band over the existing speech based telephony network facilities. Audio-visual content requires additional data facilities which creates a more complex call flow for content sharing.
1. FIG. 19 shows existing art in the mobile telecommunications network. This is labeled existing art. The various messages used to establish a mobile telephone call is vastly simplified to only show the key pieces that are relevant to the new invention. In line 1, both Subscriber 1 and Subscriber 2 have messaged the Mobile Switching Center as part of the call set-up between them.
2. In line 2, the Mobile Switching Center communicated to the Home Location Register (HLR) where the user profile information for both Subscriber 1 and Subscriber 2 was stored. In the scenario shown in FIG. 19, only Subscriber 2 has the Content Sharing Service option to simplify the call flow. The Content Sharing session would work equally well if Subscriber 1 or both subscribers had the Content Sharing service option. The Home Location Register communicated the user profile information back to the Mobile Switching Center. This information included the fact that Subscriber 2 had the Content Sharing service option. This information will serve as a trigger for subsequent activity by the Mobile Switching Center associated with the new invention.
3. FIG. 19 shows a call scenario where the two mobile telephone subscribers are in a telephone call to each other in a talking state. For the purposes of simplicity, the two subscribers are shown to be hosted on the same Mobile Switching Center but the call scenario would apply if one of the two mobile subscribers was hosted on a different telephone switch. There would be extra signaling and messaging associated with the more complex networking call scenario but that is within the current capabilities of the existing mobile telephony network regardless of the particular standard to which it operates (e.g. CDMA, GSM, etc.). The new invention described below could begin in parallel with the call set-up associated with call between Subscriber 1 and Subscriber 2 but it has been pushed out afterwards in time to make it easier to understand the new invention.
4. This is the beginning of the new invention in the call flow. Based upon the information received from the Home Location Register that one of the subscribers in the telephone had the Content Sharing service option, the Mobile Switching Center sends a message to the Content Sharing Server. The message sent to the Content Sharing Server includes the identity of the subscriber with the Content Sharing service as well as the identity of the other party the subscriber is in a telephone call with. The message also includes end user terminal capability as it affects the service option selection by the Content Sharing Server. Specifically, the capability off the subscriber's terminals to support audio, Audio-Visual or visual only capability through network connection limitations or terminal display limitations. Examples of limitations that would affect the selection of content type in the Content Sharing service include: a Terminal Device for Deaf (TDD) handset that can not directly support audio content, a terminal without any display can not show visual content. A terminal with no packet data connectivity can only receive content in-band over the telephone speech path thus limiting content to low quality audio or very low bandwidth data through a Modulator de-modulator (Modem).
5. The Content Sharing Server acknowledges receipt of the message requesting Content Sharing Service pre-service set-up by confirming it is ready for service. The Content Sharing Server has the option of denying service request back to the Mobile Switching Center if there were insufficient system resources or if the Subscriber 2 did not have a valid Content Sharing user profile established on the Content Sharing Server.
6. Assuming the Content Sharing Server did not reject the service request, and assuming the terminals used by the subscribers in the telephone call can support Audio-Visual content, the Mobile Switching Center would message the Mobile Packet Data Manager. This message includes information that the request is to support mobile Content Sharing service and the address of the hosting Content Sharing Server.
7. The Mobile Packet Data Manager establishes a data session to both subscribers in the telephone call. This would involve assigning unique packet data addresses (e.g. temporary Internet Protocol addresses using Domain Name System). The data sessions to Subscriber 1 and Subscriber 2 could be either active or dormant type data sessions at this point before the Content Sharing service has begun sending content to the subscribers. The choice is up to the Mobile telephone network operator and would be driven by network capabilities and packet data resource constraints.
8. Assuming the packet data sessions were successfully established, the Mobile Packet Data Manager messages the Content Sharing Server with the information about the packet data sessions it has established to Subscriber 1 and Subscriber 2 for the purposes of supporting Content Sharing service. The message would include the unique packet data addresses for Subscriber 1 and Subscriber 2 necessary for the Content Sharing Server to directly communicate through the mobile packet data network.
9. The Content Sharing Server sends a message to Subscriber 2, through the packet data session established by the Mobile packet manager. This message establishes a direct session between the Subscriber 2 and the Content Sharing Server. Subscriber 2 would be notified, by a software mechanism on their terminal, that the Content Sharing service is available to them for this call. The exact implementation would be operator dependent but it is foreseen that the subscriber would be presented with a menu of their content options and Content Sharing options limited by the connections and terminal display capabilities. For example, if Subscriber 1's terminal had no visual capability, then only audio Content Sharing options would be displayed to Subscriber 2 for this telephone call. Similar to the Ring Back Tone feature, the hosted content available to Subscriber 2 would be accessed through the Content Sharing Server and would be dependent upon their user profile that had been pre-established on the Content Sharing Server. Unlike Ring Back Tones, Subscriber 2 could alternatively choose to share personal content, which had been stored on their own terminal device, with Subscriber 1.
10. Some time after the telephone call is up in a talking state, Subscriber 2 triggers Content Sharing session to Subscriber 1 through their terminal. The specific trigger can vary but for this example, Subscriber 2 uses a web browser type interface to select content they want to share with Subscriber 1. The Content Sharing request and content selection message goes out from Subscriber 2 through the Mobile Packet data network to the Content Sharing Server.
11. The Content Sharing Server establishes a two way packet data connection between Subscriber 1 and Subscriber 2. The speech path remains intact and unaffected by the simultaneous data connection. Subscriber 1 and Subscriber 2 are sharing visual content as well as speech at the same time.

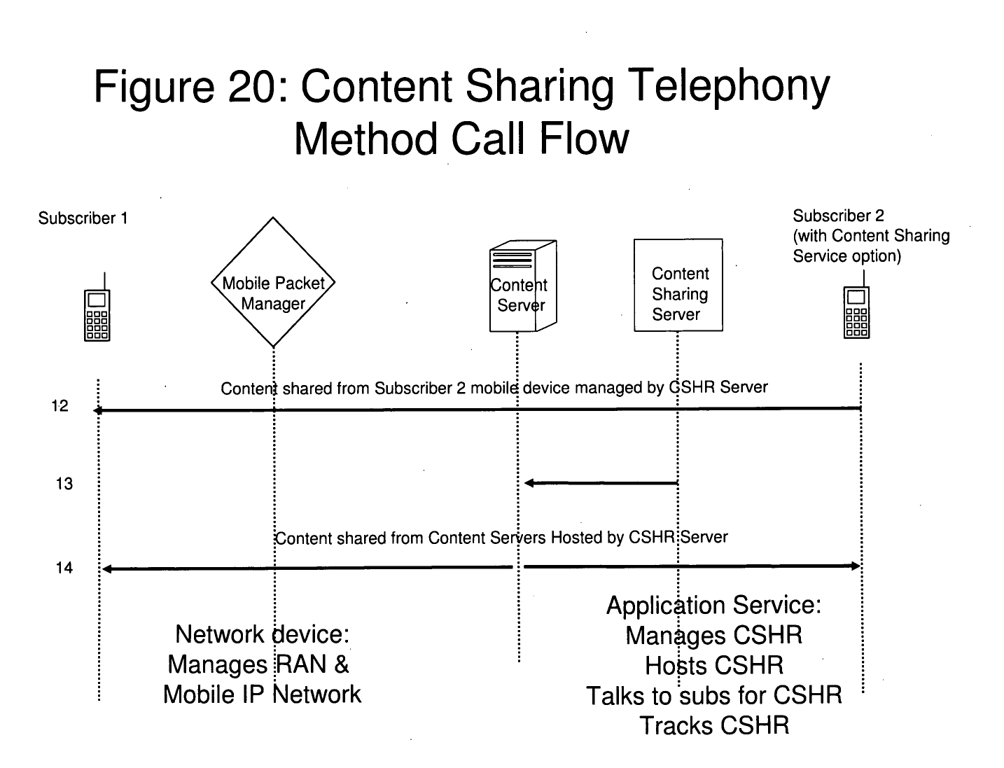

In FIG. 20, is a continuation of the call flow from FIG. 19 which is too complex to be shown in one figure. This picks up in sequence in time from the end of the call flow presented in FIG. 19.
12. The Content Sharing Server controls the Content Sharing session between the two subscribers, where Subscriber 2 chooses to send some audio-visual, visual only, or audio only content directly from their mobile device to Subscriber 1. The audio-only, visual-only, or audio-visual content, which is being shared, was stored on subscriber's 2 mobile terminal.
13. Alternatively, in line 13 and 14, the content is hosted by the Content Sharing Server, which is connected to other servers that store and play content (reference FIG. 9 for a diagram of the server architecture). After step 10, in the FIG. 19 call flow, where Subscriber 2 messages the Content Sharing Server to initiate a Content Sharing session to Subscriber 1 and indicating which content to play, the Content Sharing Server messages the Content Server to access the requested content.
14. The Content Sharing Server bridges the playback of this audio-visual, audio-only or visual-only content onto the packet data session established between the Subscriber 1 and Subscriber 2 for Content Sharing.

Subscriber 1 and Subscriber 2 are now sharing audio-only, visual-only, audio-visual content on the mobile packet data connection simultaneously as they are Sharing speech on the telephone speech path.

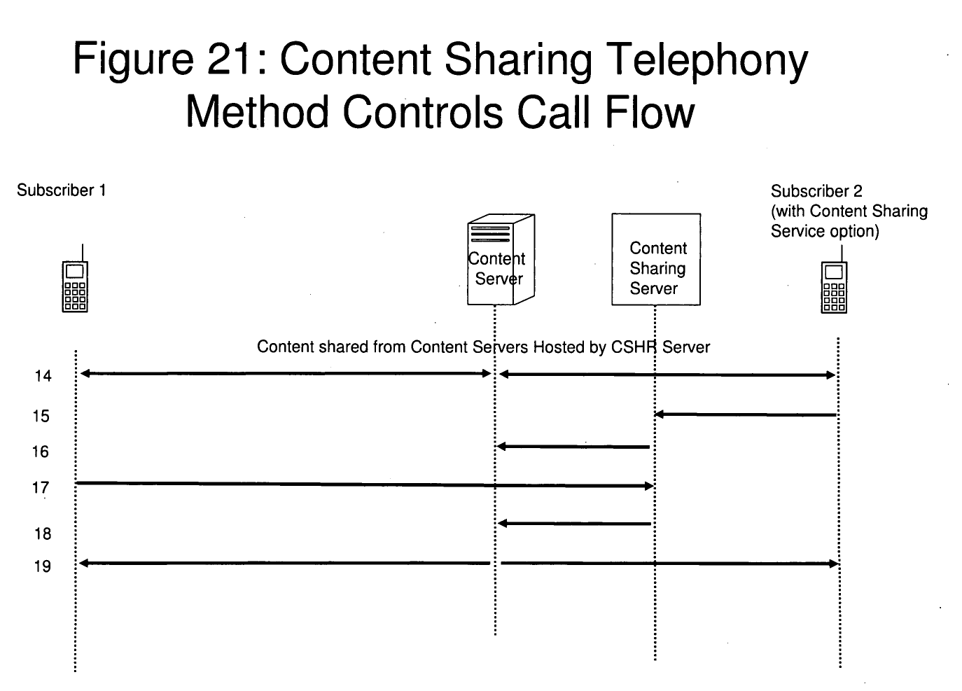

In FIG. 21 it shows the user controls to the playback of content being shared between Subscriber 1 and Subscriber 2. In this example, the content being shared is hosted content from a Content Server. This call flow scenario is similar in purpose to those presented in FIGS. 2, 3, and 4 where control mechanisms were presented for the playback of audio content on a Content Sharing session supported over the existing speech telephony network. The difference revolves around control of the playback of audio-visual content which is supported by a more complex telephony and data network involving both speech and data facilities. It picks up in sequence from where FIG. 20 left off in the call flow.
14. Line 14 is showing content being played by the Content Server over Mobile Packet data connections to both Subscriber 1 and Subscriber 2.
15. In line 15, Subscriber 2 has decided to stop playback of the content being shared. Subscriber 2 uses a software mechanism on their mobile terminal device (e.g. a web browser type interface with controls that trigger an appropriate message). This pre-defined “stop playback” message goes from Subscriber 2 to the Content Sharing Server. A range of control type messages are to be made available to the subscriber subject to the Content Sharing operator choice. Some of the user controls possible include: stop content playback, select and start play of a new piece of content, mute audio but continue playing visual content.
16. The Content Sharing Server messages the Content Server to stop playback of the content to Subscriber 1 and Subscriber 2. The Content Server then stops playing the content on the mobile packet data connection between Subscriber 1 and Subscriber 2.
17. Line 17 is showing an optional user control mechanism for a non-Content Sharing subscriber. In FIG. 19, only Subscriber 2 has the Content Sharing service. The Content Sharing service operator has the choice of offering user controls to a non Content Sharing service user, like Subscriber 1, who is in a Content Sharing session with a Content Sharing service subscriber like Subscriber 2. In this line, Subscriber 1 is shown messaging the Content Sharing Server to resume play on the content that was being shared. The control mechanism used by Subscriber 1 would be software enabled on their mobile terminal device. It could for example, be a web browser type interface with the necessary pre-defined controls to stop or start content playback.
18. The Content Sharing Server receives the control message from Subscriber 1 to resume playback of content so it messages the Content Sharing Server to resume playback.
19. The Content Server receives the message from the Content Sharing Server to resume playback of content between Subscriber 1 and Subscriber 2. It continues playing content between Subscriber 1 and Subscriber 2 on the Mobile packet data connection.

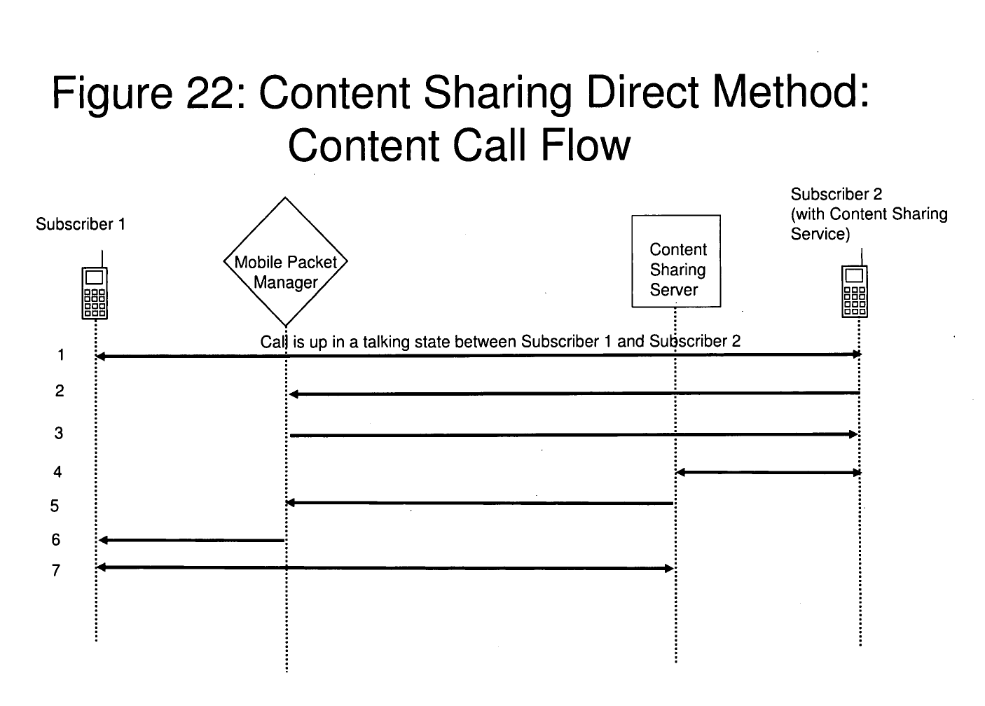

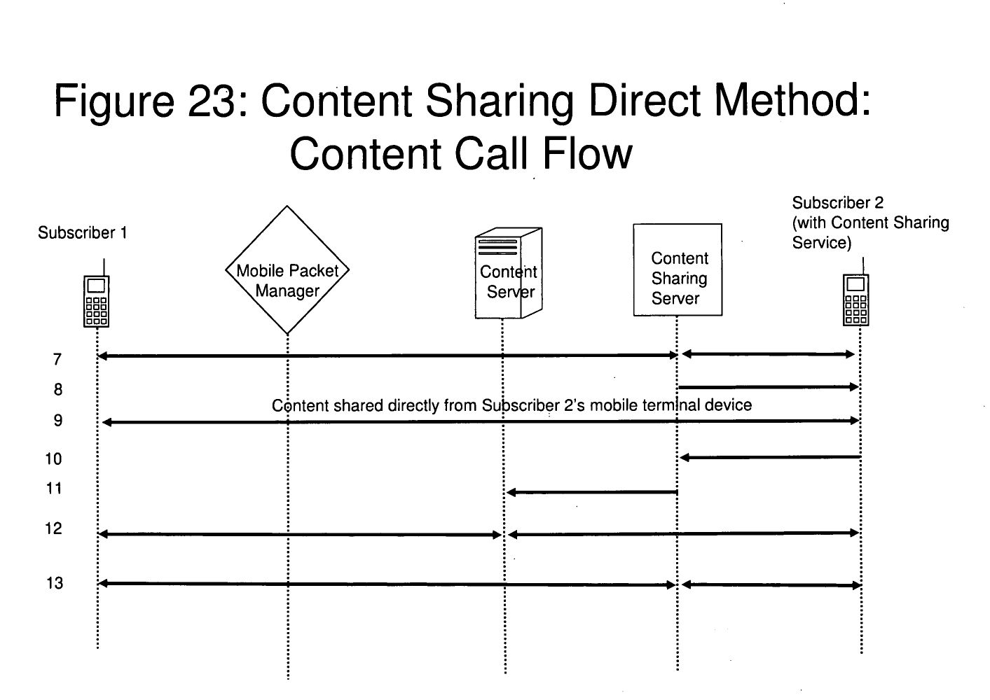

In FIGS. 22 and 23, a new call flow is presented for an alternative method of implementing Content Sharing of audio-visual content on a telephone call. While similar in purpose to the call flow from FIG. 19 which has the Telephony network controlling the Content Sharing feature, this alternative implementation has the subscriber going directly to the Content Sharing server bypassing the Telephone operating network control of the Content Sharing feature.
1. This call flow begins after a mobile telephone call is up in a talking state between Subscriber 1 and Subscriber 2. Line 1 shows the speech path between Subscriber 1 and Subscriber 2. All the events that occur after this point take place with the telephone speech path still up in a talking state. These other events occur in parallel with out affecting the telephone speech path.
2. Subscriber 2 has a Content Sharing service established with an operator who need not be the Mobile telephony network operator hosting the mobile telephone call. Subscriber 2 initiates a packet data connection to the Content Sharing Server. The subscriber does this through a software mechanism on their mobile terminal (e.g. web browser interface to a pre-defined Content Sharing Server on the packet data network) and connects through a Mobile Packet data facility available through their mobile network.
3. The Mobile Packet manager receives the request for a data connection from Subscriber 2 and provides them with the packet data connection (e.g. web browser session) to the public data network.
4. Subscriber 2 establishes a data connection to the Content Sharing Server. The Content Sharing Server establishes a Content Sharing session for Subscriber 2. Subject to the Content Sharing Server operator implementation, Content Sharing users could have pre-defined user profiles which would contain their various administrative functions that would control content choices, service levels and billing. Subscriber 2 uses the mobile packet data connection to connect to the Content Sharing Server requesting a Content Sharing connection to Subscriber 1. This message contains the number of the Subscriber 1 with whom Subscriber 2 is currently in an active telephone call.
5. The Content Sharing Server sends a message to the mobile telephone operator hosting Subscriber 1 requesting a data connection be established. We have shown the simplest network scenario where both Subscriber 1 and Subscriber 2 are hosted by the same mobile telephony network operator and where both have the same mobile packet data network manager. The scenario would equally work for a more complex call scenario where Subscriber 1 and Subscriber 2 were on different mobile telephony and mobile packet networks. There would simply be more network messaging between the network nodes. This capability lays within existing art of the mobile telephony and mobile packet data networks (e.g. CDMA-2000, GSM-GPRS, UMTS a.k.a. WCDMA a.k.a. LTE).
6. The Mobile Packet data manager establishes a data connection to Subscriber 1. This data connection can be active or dormant but in either case it does not interfere with the telephone speech path that is currently active between Subscriber 1 and Subscriber 2.
7. Subscriber 1's mobile terminal connects a data session to the Content Sharing Server which is on the public data network. The Content Sharing Server now has two active data sessions between Subscriber 1 and Subscriber 2 which can be used to share content between the subscribers.

FIG. 23 is a continuation of the complex call flow started in FIG. 22 which was too large to fit into a single figure.
7. This Line 7 in FIG. 23 pick's up in sequence from Line 7 in FIG. 22. Subscriber 1's mobile terminal connects a data session to the Content Sharing Server which is on the public data network. The Content Sharing Server now has two active data sessions between Subscriber 1 and Subscriber 2 which can be used to share content between the subscribers.
8. The Content Sharing Server has some options at this point in the call flow. In Line 8, it sends a message to Subscriber 2 notifying them that Subscriber 1 has an active data session that can be used for Content Sharing. Subscriber 2 can then chose share content.
9. In line 9, Subscriber shares content with Subscriber 1. The Content being shared is located on Subscriber's 2 mobile terminal. It is going over the data connection independent of the telephone speech path which is also active. Subscriber 1 and Subscriber 2 are now sharing content while also engaged in a telephone conversation.
10. Alternatively, the content that is to be shared could be hosted by the Content Sharing Server. In this scenario, which starts after Line 7 in this FIG. 23 Call flow. Subscriber 2 sends a message to the Content Sharing Server requesting content that is hosted by the server be shared.
11. The Content Sharing Server accesses the content requested to be played by Subscriber 2. In this scenario the content is stored on a standalone Content Server (see FIG. 9 for a network architecture diagram) although the content could be stored anywhere on the network including on the Content Sharing Server.
12. The Content Server plays the content on the data session to Subscriber 1 and Subscriber 2.
13. Alternatively, the Content Sharing Server could have been preprogrammed to immediately begin playing content once Subscriber 1 establishes a data connection. This latter scenario would start after Line 7. The content being played to both Subscriber 1 and Subscriber 2 is being played by the Content Sharing Server.

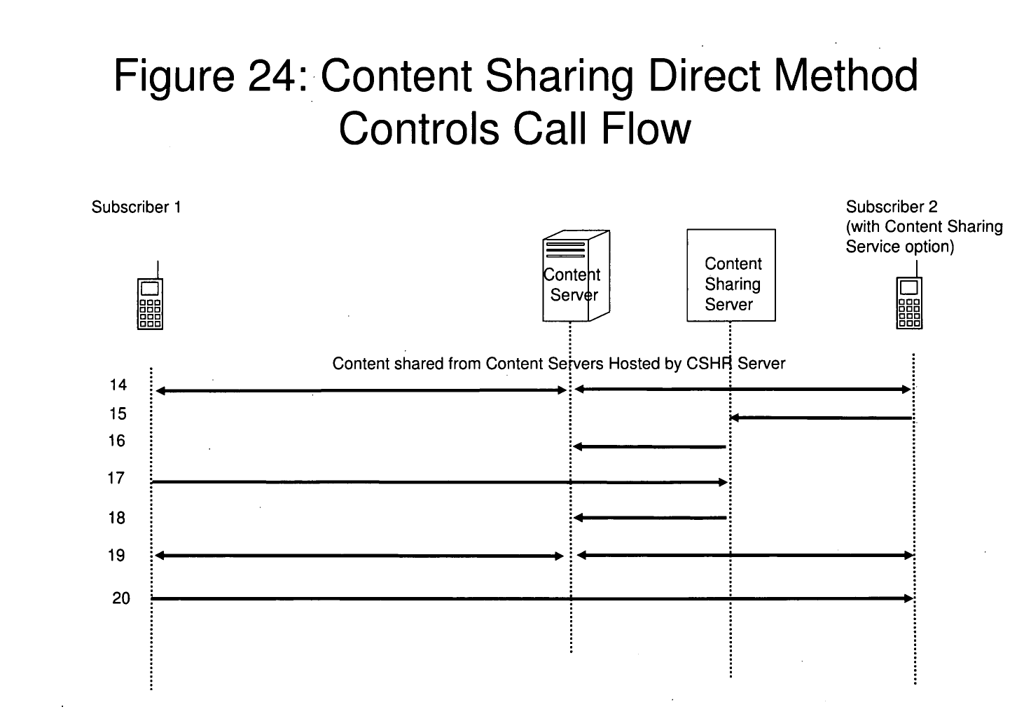

In FIG. 24 a method for subscribers to control the playback of audio-visual content in the direct to subscriber scenario is shown in a call flow diagram.
14. FIG. 24 picks up in sequence after FIG. 23. It shows the user controls to the playback of content being shared between Subscriber 1 and Subscriber 2. In this example, the content being shared is hosted content from a Content Server. Line 14 is showing content being played by the Content Server over Mobile Packet data connections to both Subscriber 1 and Subscriber 2.
15. In line 15, Subscriber 2 has decided to stop playback of the content being shared. Subscriber 2 uses a software mechanism on their mobile terminal device (e.g. a web browser type interface with controls that trigger an appropriate message). This pre-defined “stop playback” message goes from Subscriber 2 to the Content Sharing Server. A range of control type messages are to be made available to the subscriber subject to the Content Sharing operator choice. Some of the user controls possible include: stop content playback, select and start play of a new piece of content, mute audio but continue playing visual content.
16. The Content Sharing Server messages the Content Server to stop playback of the content to Subscriber 1 and Subscriber 2. The Content Server then stops playing the content on the mobile packet data connection between Subscriber 1 and Subscriber 2.
17. Line 17 is showing an optional user control mechanism for a non-Content Sharing subscriber. In FIGS. 22 and 23, only Subscriber 2 has the Content Sharing service. The Content Sharing service operator has the choice of offering user controls to a non Content Sharing service user, like Subscriber 1, who is in a Content Sharing session with a Content Sharing service subscriber like Subscriber 2. In this line, Subscriber 1 is shown messaging the Content Sharing Server to resume play on the content that was being shared. The control mechanism used by Subscriber 1 would be software enabled on their mobile terminal device. It could for example, be a web browser type interface with the necessary pre-defined controls to stop or start content playback.
18. The Content Sharing Server receives the control message from Subscriber 1 to resume playback of content so it messages the Content Sharing Server to resume playback.
19. The Content Server receives the message from the Content Sharing Server to resume playback of content between Subscriber 1 and Subscriber 2. It continues playing content between Subscriber 1 and Subscriber 2 on the Mobile packet data connection.
20. Alternatively user controls to content being shared could be implemented directly on Subscriber 2's mobile terminal device in the scenario the content being shared is located on Subscriber 2's mobile terminal device. This would pick up in sequence from Line 9 in FIG. 23. There is no messaging involved if Subscriber 2 decides to control content being played on their terminal device since it would be internal to subscriber's 2 terminal. It is an option that Subscriber 1 would be given the ability to control playback of content being shared directly by Subscriber 2. In this latter scenario, Line 20 shows a control message being sent from Subscriber 1 to stop playback of content being shared directly from Subscriber 2's mobile terminal. Subscriber 1's terminal would need predefined controls for Content Sharing to support this functionality. This could be provided by a web browser type interface that supported the Content Sharing session with some predefined controls added for common user control functions like start play or stop play of content.

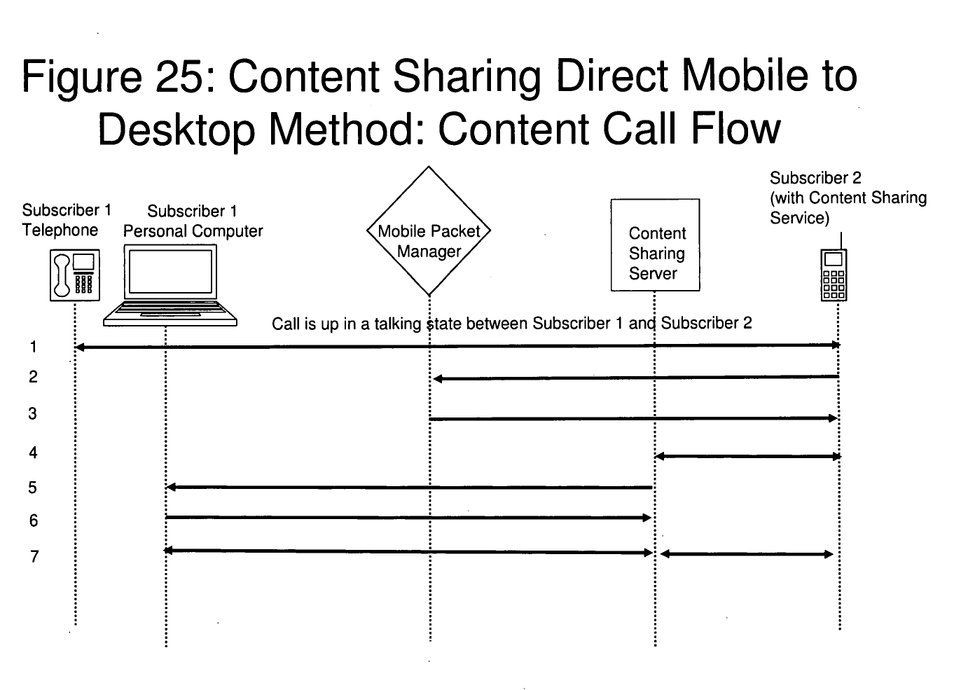

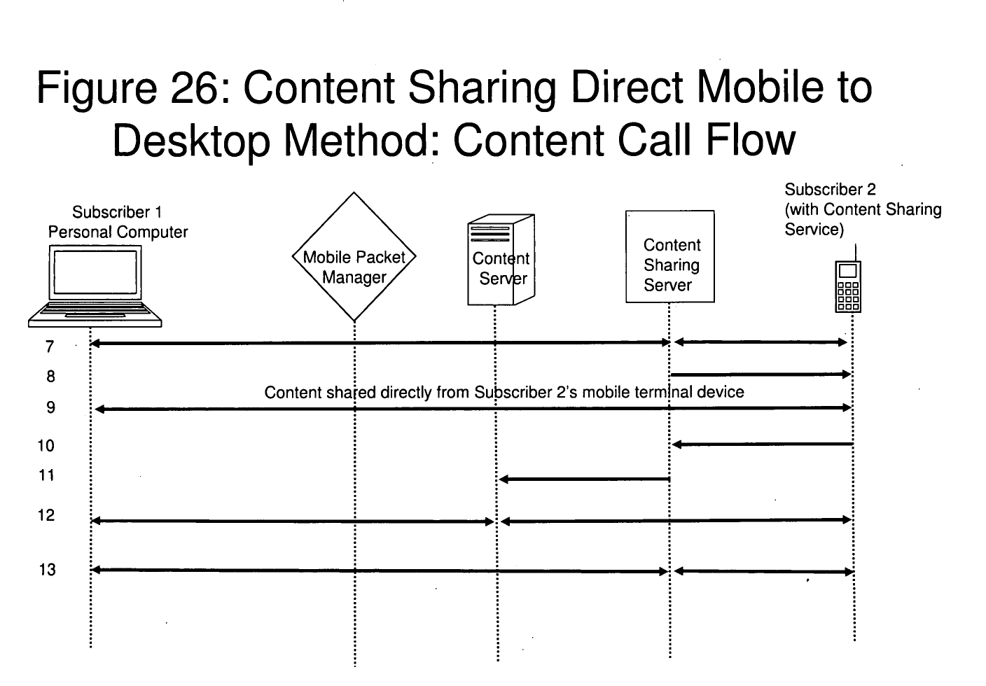

In FIGS. 25 and 26 a method for Content Sharing directly between a mobile telephony subscriber and a Wireline telephony subscriber with a Personal Computer connected to a data network is presented.
1. This call flow begins after a mobile telephone call is up in a talking state between Subscriber 1 and Subscriber 2. Line 1 shows the speech path between Subscriber 1 and Subscriber 2. Note that the key difference between this call flow, and that in FIG. 19, is that Subscriber 1 is at a fixed location with a desktop landline telephone and Personal Computer (i.e. Subscriber 1 is not mobile). All the events that occur after this point take place with the telephone speech path still up in a talking state. These other events occur in parallel with out affecting the telephone speech path.
2. Subscriber 2 has a Content Sharing service established with an operator who need not be the Mobile telephony network operator hosting the mobile telephone call. Subscriber 2 initiates a packet data connection to the Content Sharing Server. The subscriber does this through a software mechanism on their mobile terminal (e.g. web browser interface to a pre-defined Content Sharing Server on the packet data network) and connects through a Mobile Packet data facility available through their mobile network.
3. The Mobile Packet Manager receives the request for a data connection from Subscriber 2 and provides them with the packet data connection (e.g. web browser session) to the public data network.
4. Subscriber 2 establishes a data connection to the Content Sharing Server. The Content Sharing Server establishes a Content Sharing session for Subscriber 2. Subject to the Content Sharing Server operator implementation, Content Sharing users could have pre-defined user profiles which would contain their various administrative functions that would control content choices, service levels and billing. Subscriber 2 uses the mobile packet data connection to connect to the Content Sharing Server requesting a Content Sharing connection to Subscriber 1.
5. Line 5 and 6 are alternative implementations to accomplish the same objective: which is to connect Subscriber 1's desktop Personal Computer to the Content Sharing Server. In Line 5, the Content Sharing Server has the a packet data address for Subscriber 1's Personal Computer, so it sends a connection request for the Content Sharing session.
6. Line 6 alternatively shows a Content Sharing connection request originating from Subscriber 1's personal computer and going to the Content Sharing Server. In this example, Subscriber 1 received this packet address from Subscriber 2 on the telephone speech connection and typed it in on their desktop personal computer.
7. The Content Sharing Server establishes a two way data connection and Content Sharing session between Subscriber 2's mobile terminal and Subscriber 1's desktop Personal computer. Subscriber 2 is simultaneously talking to Subscriber 1 over the telephone speech path.

FIG. 26 is part of the call flow begun in FIG. 25 but was broken up into two separate figures for purposes of clarity.
7. This Line 7 in FIG. 26 pick's up in sequence from Line 7 in FIG. 25. Subscriber 1's mobile terminal connects a data session to the Content Sharing Server which is on the public data network. The Content Sharing Server now has two active data sessions between Subscriber 1 desktop personal computer and Subscriber 2's mobile terminal device which can be used to share content between the subscribers.
8. The Content Sharing Server has some options at this point in the call flow. In Line 8, it sends a message to Subscriber 2 notifying them that Subscriber 1 has an active data session that can be used for Content Sharing. Subscriber 2 can then chose share content.
9. In line 9, Subscriber shares content with Subscriber 1. The Content being shared is located on Subscriber's 2 mobile terminal. It is going over the data connection independent of the telephone speech path which is also active. Subscriber 1 and Subscriber 2 are now sharing content while also engaged in a telephone conversation (which is not shown in this figure).
10. Alternatively, the content that is to be shared could be hosted by the Content Sharing Server. In this scenario, which starts after Line 7 in this FIG. 26 Call flow (in other words ignore line 9 for this specific option). Subscriber 2 sends a message to the Content Sharing Server requesting content that is hosted by the server be shared.
11. The Content Sharing Server accesses the content requested to be played by Subscriber 2. In this scenario the content is stored on a standalone Content Server (see FIG. 9 for a network architecture diagram) although the content could be stored anywhere on the network including on the Content Sharing Server.
12. The Content Server plays the content on the data session to Subscriber 1 and Subscriber 2.
13. Alternatively, the Content Sharing Server could have been preprogrammed to immediately begin playing content once Subscriber 1 establishes a data connection. This latter scenario would start after Line 7 (ignore lines 8 through 12 for this specific option). The content being played to both Subscriber 1 and Subscriber 2 is being played by the Content Sharing Server.

### INDUSTRIAL APPLICABILITY

The Ring-Back Tone service has been commercially very successful since it was first deployed in a mobile telephony network in 2005, in South Korea by SKTel. The Ring-Back Tone Service is still growing in the subscriber base across mobile telephony networks worldwide. The proposed Content Sharing service will have a commercial application similar to that Ring-Back Tone service. Telephone subscribers will be able to share popular music and conversation providing a better shared experience for all the parties on the telephone call.

Existing IP capable terminals can be used by subscribers to share and exchange files directly. This technology however is very problematic for the original content providers since they lose visibility and control over their content. The Digital Rights Management issue is a concern for content providers so any technology which allows for the controlled sharing of content is desirable from the content provider point of view. The use of a Content Server to provide and control content to subscribers from a centralized point in the telephony network addresses in part the file sharing issue. This makes the distribution of content via the Content Sharing service useful to content providers since it provides them with a safer channel to distribute their content to end-users.

### Novelty

It is true that no new telephony network components are necessary to support the proposed Content Sharing Service for telephony subscribers. A similar type of service, the Ring-Back Tone service has been deployed across major mobile telephony networks worldwide in the last two years. The video telephony standards, which are forward looking, have also defined Video RingBack Tone service mirroring the audio telephony network method. Yet the problems identified by this inventor have not been addressed by anyone in the industry to date. The original subscriber-based ring-back-tone-service was developed to fill the time interval before the two parties were in a talking state. The Content Sharing service for telephone subscribers is used after the call is set up and in a talking state. The lack of user controls directly over the audio track being played by the Ring-Back Tone Server was not perceived to be a big problem because the audio track was only played for a short interval prior to the Called party answering the call or having the call roll over to voice mail. Nor was the fact the Called party could not hear the audio track played by the Ring-Back Tone Server seen as a problem because the Ring-Back-tone-service was only supposed to play before the Called party answered the call. In other words, the audio track being played by the RingBack Tone Server was not perceived to be a shared user experience between the Calling party and the Called party. It is not an obvious step to go from providing a few seconds of Ring-Back Tone to the just Calling party prior to the call being in a talking state to sharing long tracks of music from a content server between two telephone subscribers after the call is in a talking state.

What I claim:

1. A Method for Sharing Audio-only content between Subscribers on an active telephone call where the Content Sharing service is controlled by the telephone network.

2. A method of claim 1 wherein the users can control the playback of the audio-only content being shared where the Content Sharing service is controlled by the telephone network.

3. A method of claim 1 wherein users can select audio-only content to be played where the Content sharing service is controlled by the telephone network.

4. A Method for Sharing Audio-Visual content and Visual-only content between Subscribers on an active telephone call in a network controlled by the telephony system operator.

5. A method of claim 4 wherein the users can control the playback of the audio-visual and visual-only content being shared where the Content Sharing service is controlled by the telephone network.

6. A method of claim 4 wherein the users can select audio-visual and visual-only content to be played where the Content sharing service is controlled by the telephone network.

7. A Method for Sharing Audio-only content between Subscribers on an active telephone call where the Content Sharing service is controlled by the subscriber directly.

8. A method of claim 7 wherein the users can control the playback of the audio-only content being shared and where the Content Sharing service is controlled by the subscriber directly.

9. A method of claim 7 wherein the users can select audio-only content to be played where the Content sharing service is controlled by the subscriber directly.

10. A Method for Sharing audio-visual and visual-only content between Subscribers on an active telephone call where the Content Sharing service is controlled by the subscriber directly.

11. A method of claim 10 wherein the users can control the playback of the audio-visual and visual-only content being shared where the Content Sharing service is controlled by the subscriber directly.

12. A method of claim 10 wherein the users can select audio-visual and visual-only content to be played where the Content sharing service is controlled by the subscriber directly.

13. A Method for the Calling party to control the playback of Ring-Back Tone on a telephone call.

14. A Method for the Calling party to control the playback of Video Ring-Back Tone on a telephone call.

15. A Method for providing a subscriber who is equipped with both the Ring-Back Tone and Video Ring-Back Tone service options the ability to predefine the playback preferences.

16. A Method for Sharing Audio-only content between Subscribers on an active telephone call where the telephone networks Three Way (3-Way) calling feature is used to create an audio bridge to the Content Sharing server hosting a subscriber's audio content.

17. A Method of claim 1 wherein the one of the subscribers on an active telephone with an audio-only content sharing session three way call another party and bridge them onto the active call and content sharing session.

18. A Method of sharing audio-visual content between a mobile subscriber and a Wireline telephony subscriber who also has a personal computer connected to a data network.
